(19) United States
(12) Patent Application Publication
(10) Pub. No.: US 2026/0353503 A1
(43) Pub. Date: Nov. 5, 2026

(54) METHOD AND APPARATUS FOR TRANSMITTING INFORMATION, COMMUNICATION DEVICE, AND STORAGE MEDIUM

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd., Beijing (CN)

(21) Appl. No.: 18/997,691

(22) PCT Filed: Jul. 29, 2022
(86) PCT No.: PCT/CN2022/109269

§ 371 Date: Jan. 22, 2025

(51) Int. Cl. H04W 76/28

(52) U.S. Cl. CPC H04W 76/28

(57) ABSTRACT

A method for transmitting information includes: sending discontinuous reception (DRX) configuration information by a network device to a user equipment (UE), where the DRX configuration information is used for indicating N DRX cycle configuration parameters, where the N DRX cycle configuration parameters include at least one of: I DRX long-cycle configuration parameters or J DRX short-cycle configuration parameters, N, I and J are natural numbers, and at least one of I or J being greater than or equal to 2.

### CROSS-REFERENCE TO RELATED APPLICATIONS

The present application is a U.S. National Stage of International Application No. PCT/CN2022/109269 filed on Jul. 29, 2022, the contents of all of which are incorporated herein by reference in their entireties for all purposes.

### BACKGROUND OF THE INVENTION

In a cellular mobile communication system, a discontinuous reception (DRX) mechanism has been introduced in order to save power consumption of user equipment (UE). That is, when the UE is in a connected state, it does not need to continuously monitor a control channel of a base station, but intermittently monitor the control channel.

### SUMMARY OF THE INVENTION

Examples of the disclosure disclose a method and apparatus for transmitting information, a communication device and a storage medium.

A method for transmitting information is provided, performed by a network-side device, including: sending discontinuous reception (DRX) configuration information to user equipment (UE); where the DRX configuration information is used for indicating N DRX cycle configuration parameters, where the N DRX cycle configuration parameters include at least one of: I DRX long-cycle configuration parameters or J DRX short-cycle configuration parameters, where N, I and J are natural numbers, and at least one of I or J is greater than or equal to 2.

A method for transmitting information is provided, performed by user equipment (UE), including: receiving discontinuous reception (DRX) configuration information sent by a network-side device; where the DRX configuration information is used for indicating N DRX cycle configuration parameters, where the N DRX cycle configuration parameters include at least one of: I DRX long-cycle configuration parameters or J DRX short-cycle configuration parameters, where N, I and J are natural numbers, and at least one of I or J is greater than or equal to 2.

A communication device is provided, including: one or more processors and a memory configured to store an executable instruction for the one or more processors; where the one or more processors are collectively configured to: implement the method for transmitting information when running the executable instruction.

A non-transitory computer-readable storage medium is provided, storing a computer executable program, and when the computer executable program is executed by one or more processors, the method for transmitting information is implemented.

It is to be understood that the above general descriptions and later detailed descriptions are merely examples and illustrative, and cannot limit the examples of the disclosure.

### BRIEF DESCRIPTION OF DRAWINGS

FIG. 1 is a schematic structural diagram of a wireless communication system.

FIG. 2 is a schematic diagram of DRX illustrated according to an example.

FIG. 3 is a schematic diagram of a change in a data transmission cycle illustrated according to an example.

FIG. 4 is a schematic diagram of a restart position of a timer illustrated according to an example.

FIG. 5 is a flowchart of a method for transmitting information illustrated according to an example.

FIG. 6 is a flowchart of a method for transmitting information illustrated according to an example.

FIG. 7 is a flowchart of a method for transmitting information illustrated according to an example.

FIG. 8 is a flowchart of a method for transmitting information illustrated according to an example.

FIG. 9 is a flowchart of a method for transmitting information illustrated according to an example.

FIG. 10 is a flowchart of a method for transmitting information illustrated according to an example.

FIG. 11 is a flowchart of a method for transmitting information illustrated according to an example.

FIG. 12 is a flowchart of a method for transmitting information illustrated according to an example.

FIG. 13 is a block diagram of an apparatus for transmitting information illustrated according to an example.

FIG. 14 is a block diagram of an apparatus for transmitting information illustrated according to an example.

FIG. 15 is a block diagram of UE illustrated according to an example.

FIG. 16 is a block diagram of a base station illustrated according to an example.

### DETAILED DESCRIPTION OF THE INVENTION

Examples will be illustrated in detail here, and their instances are shown in the accompanying drawings. When the following description refers to the accompanying drawings, unless otherwise indicated, the same numbers in different accompanying drawings indicate the same or similar elements. Implementations described in the following examples do not represent all implementations consistent with the examples of the disclosure. Rather, they are merely instances of apparatuses and methods consistent with some aspects of the examples of the disclosure as detailed in the appended claims.

Terms used in the examples of the disclosure are merely for the purpose of describing specific examples, and are not intended to limit the examples of the disclosure. Singular forms “one” and “the” used in the examples of the disclosure and the appended claims are also intended to include plural forms unless the context clearly indicates other meanings. It is also to be understood that a term “and/or” as used here refers to and contains any or all combinations of one or more associated listed items.

The present disclosure relates to, but is not limited to, the technical field of communications, in particular to a method and apparatus for transmitting information, a communication device and a storage medium.

It is to be understood that although terms first, second, third, etc. may be used to describe various information in the examples of disclosure, such information is not to be limited to these terms. These terms are merely used to distinguish the same type of information from each other. For example, without departing from the scope of the examples of the disclosure, first information may also be referred to as second information, and similarly, the second information may also be referred to as the first information. Depending on the context, for example, a word “if” as used here may be interpreted as “at the time” or “when” or “in response to determining”.

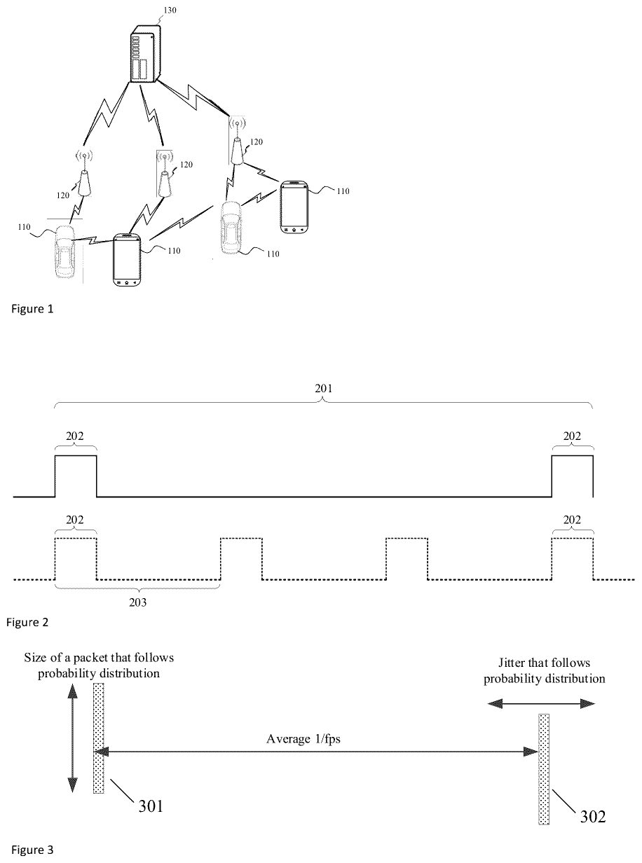

Referring to FIG. 1, it shows a schematic structural diagram of a wireless communication system provided by an example of the disclosure. As shown in FIG. 1, the wireless communication system is a communication system based on a cellular mobile communication technology. The wireless communication system may include: a plurality of pieces of user equipment 110 and a plurality of base stations 120.

The user equipment 110 may refer to devices that provide a user with at least one of speech connectivity or data connectivity. The user equipment 110 may communicate with one or more core networks via a radio access network (RAN), and the user equipment 110 may be Internet of Things user equipment, such as a sensor device, a mobile phone (or “cellular” phone), and a computer with Internet of Things user equipment, which may be, for example, fixed, portable, pocket-sized, handheld, computer-built, or vehicle-mounted apparatuses, for example, a station (STA), a subscriber unit, a subscriber station, a mobile station, a mobile, a remote station, an access point, a remote terminal, an access terminal, a user terminal, a user agent, a user device, or user equipment. Alternatively, the user equipment 110 may also be unmanned aircraft devices. Alternatively, the user equipment 110 may also be vehicle-mounted devices, such as a trip computer with a wireless communication function, or wireless communication equipment connected with an external trip computer. Alternatively, the user equipment 110 may also be roadside devices, such as a street lamp, a signal light or other roadside devices with wireless communication functions.

The base stations 120 may be network side devices in the wireless communication system. The wireless communication system may be the 4th generation mobile communication (4G) technology system, also known as a long term evolution (LTE) system; alternatively, the wireless communication system may be a 5G system, also known as a new radio system or 5G NR system. Alternatively, the wireless communication system may also be a next-generation system of the 5G system. An access network in the 5G system may be called a new generation-radio access network (NG-RAN).

The base stations 120 may be evolved base stations (eNB) used in the 4G system. Alternatively, the base stations 120 may also be base stations adopting centralized and distributed architectures (gNB) in the 5G system. When the base stations 120 adopt the centralized and distributed architectures, they typically each include a central unit (CU) and at least two distributed units (DUs). Protocol stacks of a packet data convergence protocol (PDCP) layer, a radio link control (RLC) protocol layer, and a media access control (MAC) layer are arranged in the central unit. A physical (PHY) layer protocol stack is arranged in the distributed unit. The examples of the disclosure do not limit specific implementation of the base stations 120.

Wireless connections may be established between the base stations 120 and the user equipment 110 through a radio interface. In different implementations, the radio interface is a radio interface based on the 4th generation mobile communication (4G) technology standard; or, the radio interface is a radio interface based on the 5th generation mobile communication (5G) technology standard, such as new radio; or, the radio interface may also be a radio interface based on the next-generation mobile communication technology standard of 5G.

In some examples, end to end (E2E) connections may also be established between the user equipment 110, for example, a vehicle to vehicle (V2V) communication, a vehicle to infrastructure (V2I) communication, a vehicle to pedestrian (V2P) communication and other scenarios in vehicle to everything (V2X) communications.

Here, the above user equipment may be considered to be a terminal device of the following example.

In some examples, the wireless communication system above may further include a network management device 130.

The plurality of base stations 120 are connected with the network management device 130. The network management device 130 may be a core network device in the wireless communication system. For example, the network management device 130 may be a mobility management entity (MME) in an evolved packet core (EPC). Alternatively, the network management device may also be other core network devices, such as a serving gateway (SGW), a public data network gateway (PGW), a policy and charging rules function (PCRF) unit or a home subscriber server (HSS). An implementation form of the network management device 130 is not limited in the examples of the disclosure.

In order to facilitate understanding by those skilled in the art, the examples of the disclosure set forth a plurality of implementations to clearly illustrate the technical solutions of the examples of the disclosure. Certainly, it may be understood by those skilled in the art that the plurality of examples provided in the disclosure may be executed individually, or together with methods of the other examples in the examples of the disclosure when combined, or together with some methods in other related arts after executed individually or in combination, which is not limited by the examples in the disclosure.

In a cellular mobile communication system, a discontinuous reception (DRX) mechanism has been introduced in order to save power consumption of user equipment (UE). That is, when the UE is in a connected state, it does not need to continuously monitor a control channel of a base station, but intermittently monitor the control channel. During an OnDuration period, the UE monitors the control channel, during which a radio frequency channel is turned on and continuously monitors the control channel. At times other than the OnDuration period, the UE is in a power-saving state, and its radio frequency link is turned off.

As shown in FIG. 2, On Duration 202 occurs cyclically, and a specific cycle is realized by a configuration of a network-side device such as a base station. Concepts of DRX long cycle 201 and DRX short cycle 203 are introduced in order to achieve a purpose of power saving of UE, and at the same time, in order to avoid an excessive transmission delay between the base station and the UE. On Duration 202 occurs more frequently in a DRX short cycle 203 than in a DRX long cycle 201. If the UE is configured with both the DRX long cycle 201 and the DRX short cycle 203, after the DRX short cycle 203 is started, monitoring is performed by the UE in accordance with the DRX long cycle after a drx-ShortCycleTimer of the DRX short cycle times out.

On Duration 202 starting positions of the DRX long cycle 201 and the DRX short cycle 203 are as follows:

if the DRX short cycle is used in a DRX group and a following expression is met:

[(SFN×10)+subframe number] modulo (drx-ShortCycle)=(drx-StartOffset) modulo (drx-ShortCycle),
a drx-onDurationTimer is started after delaying drx-SlotOffset at a start position of a subframe.

If the DRX long cycle is used in the DRX group and a following expression is met:

[(SFN×10)+subframe number] modulo (drx-LongCycle)=drx-StartOffset,
the drx-onDuration Timer is started after delaying drx-SlotOffset at a start position of a subframe.

The general DRX configuration parameters include the following parameters:
drx-onDurationTimer: a time interval from a beginning of a DRX cycle, which is an active time
drx-SlotOffset: a time delay before the drx-onDurationTimer is started
drx-InactivityTimer: for a current MAC entity, a duration after a PDCCH indicates new uplink or downlink transmission.
drx-RetransmissiontimerDL (for a downlink hybrid automatic repeat request (HARQ) process other than a broadcast): a maximum duration until downlink retransmission is received.
drx-RetransmissiontimerUL (for an uplink HARQ process): a maximum duration until an uplink authorization for uplink retransmission is received.
drx-LongCycleStartOffset: it indicates the drx-LongCycle and drx-StartOffset and specifies start positions of the long and short DRX cycles.
drx-ShortCycle (optional): the DRX short cycle.
drx-ShortCycle Timer (optional): the number of durations for which the DRX short cycle is used by the UE. It represents how many continuous subframes in the short cycle enter the long cycle without receiving the PDCCH.
drx-HARQ-RTT-timerDL (for a downlink HARQ other than a broadcast): a minimum duration expected by an MAC entity before downlink resource allocation control signaling for downlink HARQ retransmission is received.
drx-HARQ-RTT-timerUL (for an uplink HARQ process): a minimum duration expected by the MAC entity before uplink authorization signaling for uplink HARQ retransmission is received.

A value range of the drx-LongCycle in a general DRX configuration is (10 ms, 20 ms, 32 ms, 40 ms, 60 ms, 64 ms, 70 ms, 80 ms, 128 ms, 160 ms, 256 ms, 320 ms). A value range of the drx-ShortCycle is (2 ms, 3 ms, 4 ms, 5 ms, 6 ms, 7 ms, 8 ms, 10 ms, 14 ms, 16 ms, 20 ms, 30 ms, 32 ms, 35 ms, 40 ms, 64 ms, 80 ms, 128 ms, 160 ms, 256 ms, 320 ms, 512 ms, 640 ms).

An extended reality (XR for short) service is one of types of services that a 5G system is intended to support, and XR includes AR/VR/Cloud gaming, etc. Typical service characteristics of the XR are that for a fixed frame rate service, there is a fixed cycle for the service to reach the UE, but there is additional delay jitter on this fixed cycle, and thus the actual data service reaches the UE either earlier or later. A schematic diagram of an XR service reach model is shown in FIG. 3: (an example with a frame rate of 60 frames per second (FPS), i.e., a cycle of 16.67 ms and a jitter range of [4, −4] ms). Packet K 301 represents an IP packet belonging to a video frame K, and packet K+1 301 represents an IP packet belonging to a video frame K+1. Packet size and jitter follow a probability distribution.

But for the XR service, it is often composed of a plurality of data streams, where a cycle of each stream is likely to be different.

Thus, how to make the DRX cycle able to meet the demands of different cycles of the XR data streams is an urgent problem to be solved.

As shown in FIG. 4, an example of the disclosure provides a method for transmitting information, performed by a network-side device, including step 401.

Step 401: DRX configuration information is sent to UE; where the DRX configuration information is used for indicating N DRX cycle configuration parameters, where the N DRX cycle configuration parameters include at least one of: I DRX long-cycle configuration parameters or J DRX short-cycle configuration parameters, where N, I and J are natural numbers, and at least one of I or J is greater than or equal to 2.

Here, the network-side device may be an access network device such as a base station, or a core network device.

In an implementation, the DRX configuration information may be determined and sent to the UE by the access network device.

In an implementation, the DRX configuration information may be determined by the core network device and sent to the UE by the access network device.

The DRX cycle configuration parameters may be a set of DRX cycle configuration parameters associated with a DRX cycle, and a DRX cycle configuration parameter may be composed of a plurality of sub-parameters.

For example, the DRX cycle configuration parameters may include, but are not limited to, the following sub-parameters: cycle (i.e., DRX Cycle), OnDuration duration, discontinuous reception inactivity timer (DRX-InactivityTimer, DRX IAT timer) duration, drx-SlotOffset (i.e., a delay before a drx-onDurationTimer is started), and drx-StartOffset (i.e. start offset). For a DRX long cycle, the configuration parameters may further include: Long DRX Cycle, etc.; and the DRX short-cycle configuration parameters may further include: Short DRX Cycle, and short-cycle duration (drx-ShortCycleTimer).

In an implementation, DRX cycles are different in different DRX cycle configuration parameters. Here, the DRX cycles may include at least one of: long DRX cycles or short DRX cycles.

The network-side device may configure at least one of: a plurality of DRX long-cycle configuration parameters or a plurality of DRX short-cycle configuration parameters, which are used for meeting demands of different services, e.g., an XR service, for data transmission cycles.

For example, when a data transmission cycle is shorter, transmission may be performed using an OnDuration period in a DRX cycle configuration parameter with a shorter cycle, and thus a case of a data transmission delay due to a longer cycle of a DRX cycle is reduced. A service real-time performance is improved.

In an implementation, the network-side device may configure a plurality of DRX long-cycle configuration parameters and a DRX short-cycle configuration parameter.

In an implementation, the network-side device may configure a DRX long-cycle configuration parameter and a plurality of DRX short-cycle configuration parameters.

In an implementation, the network-side device may configure a plurality of DRX long-cycle configuration parameters and not configure DRX short-cycle configuration parameters.

In an implementation, sending the DRX configuration information to user equipment (UE) includes at least one of the following: sending a radio resource control (RRC) message carrying the DRX configuration information to the UE; sending downlink control information (DCI) carrying the DRX configuration information to the UE; or sending a medium access control control element (MAC CE) carrying the DRX configuration information to the UE.

The DRX configuration information may be used for indicating sub-parameters of a DRX cycle configuration parameter, or, a piece of DRX configuration information may be used for indicating a sub-parameter of a DRX cycle configuration parameter, or, a piece of DRX configuration information may be used for indicating all sub-parameters of n DRX cycle configuration parameters, where n is a positive integer less than or equal to N. The number of sub-parameters that a piece of DRX configuration information may indicate is not limited here.

In an implementation, each of the plurality of pieces of DRX configuration information sent to the UE by the network-side device may indicate a sub-parameter of the DRX cycle configuration parameter. A plurality of pieces of DRX configuration information may be sent to the UE by the network-side device through single signaling, and a plurality of pieces of DRX configuration information may be sent to the UE by the network-side device through a plurality of pieces of signaling, which is not limited by this example here.

For example, a DRX cycle configuration parameter (DRX long-cycle configuration parameter or DRX short cycle configuration parameter) may correspond to a plurality of pieces of DRX configuration information, and the plurality of pieces of DRX configuration information each indicates a sub-parameter of the DRX cycle. Each piece of DRX configuration information may be carried by an informatica element (IE).

In this way, by configuring the plurality of DRX cycle configuration parameters, DRX meets cycle changes of different service data transmission, a data transmission delay generated due to the inconsistency between a service data transmission cycle and the DRX cycle is reduced, a data transmission demand is met while UE power is saved, and data transmission efficiency is improved.

In an example, the different DRX configuration information is used to indicate sub-parameters in the different DRX cycle configuration parameters.

Here, sub-parameters of the different DRX cycle configuration parameters may be configured separately adopting different DRX configuration information. That is, the DRX configuration parameters include the first information, and the first information is used to indicate a sub-parameter specific to each of the DRX cycle configuration parameters. The first information is used to indicate sub-parameters in different DRX short-cycle configurations. That is, sub-parameters in different DRX short-cycle configurations are indicated by different first information.

In an implementation, a piece of DRX configuration information is used to indicate a DRX cycle configuration parameter, and DRX configuration information corresponding to different DRX cycles is different.

In an implementation, a piece of DRX configuration information is used for indicating a sub-parameter of a configuration parameter of a DRX cycle, and DRX configuration information of different sub-parameters is different.

In an implementation, configuration parameters of different DRX cycles may be the same or different.

For example, DRX configuration information of each DRX cycle configuration parameter occupies an independent IE.

For example, a network side may configure at least one of: two sets of DRX long-cycle configuration parameters or two sets of DRX short-cycle configuration parameters, DRX configuration information of each set of DRX long-cycle configuration parameters occupies an independent IE, and DRX configuration information of each set of DRX short-cycle configuration parameters occupies an independent IE.

Specific configurations are as follows.
A first set of DRX long-cycle configuration parameters: duration of cycle 1, OnDuration duration 1, and discontinuous reception inactivity timer (DRX-InactivityTimer, DRX IAT timer) duration 1 . . .
A second set of DRX long-cycle configuration parameters: cycle 2, OnDuration duration 2, DRX IAT timer duration 2 . . .
A first set of DRX short-cycle configuration parameters: cycle 1, OnDuration duration 1, DRX IAT timer duration 1; short-cycle duration (drx-ShortCycleTimer) 1 . . .
A second set of DRX short-cycle configuration parameters: cycle 2, OnDuration duration 2, DRX IAT timer duration 2; short-cycle duration (drx-ShortCycleTimer) 2 . . .

In an example, one piece of the DRX configuration information is used for indicating sub-parameters of the same type in the plurality of DRX cycle configuration parameters.

The DRX configuration parameters include second information, and the second information is used for indicating a common sub-parameter of the M DRX cycle configuration parameters, where M is a positive integer less than or equal to N.

Here, a piece of second information may be used for indicating sub-parameters of a same type in the M DRX cycle configuration parameters, where M is a positive integer less than or equal to N.

Here, sub-parameters of the same type in a plurality of DRX cycle configuration parameters (at least one of DRX long-cycle configuration parameters or DRX short-cycle configuration parameters) may share (multiplex) one or more pieces of DRX configuration information. That is, a plurality of DRX cycle configuration parameters adopt sub-parameters indicated by the same piece of DRX configuration information. Here, a piece of DRX configuration information may indicate one or more sub-parameters.

For example, the network side may configure at least one of: two sets of DRX long-cycle configuration parameters or two sets of DRX short-cycle configuration parameters, where some of sub-parameters may be multiplexed, i.e., the multiplexed sub-parameters may be common to a plurality of sets of configurations, and other sub-parameters are configured separately. Specific configurations are as follows.
A first set of DRX long-cycle configuration parameters: cycle 1, . . .
A second set of DRX long-cycle configuration parameters: cycle 2, . . .
A first set of DRX short-cycle configuration parameters: cycle 1, short-cycle duration (drx-ShortCycleTimer) 1 . . .
A second set of DRX short-cycle configuration parameters: cycle 2, short-cycle duration (drx-ShortCycleTimer) 2 . . .

The above sub-parameters are indicated by the respective DRX configuration information corresponding to each DRX cycle configuration parameter, and other sub-parameters such as OnDuration duration and DRX IAT timer duration may be indicated by the multiplexed DRX configuration information. The multiplexed DRX configuration information may indicate sub-parameters of one or more types. The multiplexed DRX configuration information may be sent separately. The multiplexed DRX configuration information may also belong to a predetermined DRX cycle, and other DRX cycles may multiplex the multiplexed DRX configuration information of this predetermined DRX cycle.

In an example, the DRX configuration information corresponding to a sub-parameter in the DRX long-cycle configuration parameters is used for indicating a sub-parameter in the DRX short-cycle configuration parameters.

For example, the network side may configure DRX long-cycle configuration parameters and DRX short-cycle configuration parameters, where a DRX short cycle may multiplex some of sub-parameters of a DRX long cycle, i.e., DRX configuration information of the DRX long-cycle configuration parameters may be used for indicating sub-parameters in the DRX short-cycle configuration parameters. Specific configurations are as follows.
A first set of DRX long-cycle configuration parameters: cycle 1, OnDuration duration 1 . . .
A second set of DRX long-cycle configuration parameters: cycle 2, OnDuration duration 1 . . .
A first set of DRX short-cycle configuration parameters: cycle 1, short-cycle duration (drx-ShortCycleTimer) 1 . . .
A second set of DRX short-cycle configuration parameters: cycle 2, short-cycle duration (drx-ShortCycleTimer) 2 . . .

The above sub-parameters may be indicated by DRX configuration information corresponding to each DRX cycle configuration parameter respectively. Other sub-parameters such as OnDuration duration and DRX IAT timer duration may be indicated by the DRX long-cycle configuration parameters. That is, one or more sub-parameters in the DRX short-cycle configuration parameters may multiplex one or more sub-parameters in the DRX long-cycle configuration parameters.

In an example, in response to that a sub-parameter of a first DRX cycle configuration parameter of the N DRX cycle configuration parameters does not have the corresponding DRX configuration information, the sub-parameter of the first DRX cycle configuration parameter is determined in at least one of the following modes: the sub-parameter of the first DRX cycle configuration parameter is specified by a communication protocol; the sub-parameter of the first DRX cycle configuration parameter is a preset value; or, the sub-parameter of the first DRX cycle configuration parameter is indicated by the DRX configuration information of a second DRX cycle configuration parameter of the N DRX cycle configuration parameters.

Here, the DRX configuration information of the first DRX cycle configuration parameter may not directly indicate one or more sub-parameters in the first DRX cycle configuration parameter so as to reduce the amount of data of the DRX configuration information and save signaling overhead.

The DRX configuration information of the first DRX cycle configuration parameter does not directly indicate one or more sub-parameters in the first DRX cycle configuration parameter, and may be specified by a communication protocol to take a value, or, may take a preset value (e.g., a default value).

One or more sub-parameters in the first DRX cycle configuration parameter are not directly indicated by the DRX configuration information of the first DRX cycle configuration parameter, but may also be indicated by the DRX configuration information of the second DRX cycle configuration parameter, i.e., the DRX configuration information of the second DRX cycle configuration parameter may be multiplexed for the one or more sub-parameters of the first DRX cycle configuration parameter.

In an implementation, there may be one or more of first DRX cycle configuration parameters.

For example, the network side is configured with two DRX cycle configuration parameters, where: a certain IE (the IE corresponding to a sub-parameter) is not configured in the second DRX cycle configuration parameter, and then it means that a value of a corresponding sub-parameter IE in the first DRX cycle configuration parameter is multiplexed. Here, the IE may be an IE in the DRX configuration information.

Alternatively, a certain IE (the IE corresponding to a sub-parameter) is not configured in the second DRX cycle configuration parameter, and then it means that a default value is taken or a value is agreed by a protocol. Here, the IE may be an IE in the DRX configuration information.

In an example, the first DRX cycle configuration parameter is a DRX short-cycle configuration parameter, and the second DRX cycle configuration parameter is a DRX long-cycle configuration parameter.

For example, the network side is configured with a DRX long-cycle configuration parameter and a DRX short-cycle configuration parameter, where a certain IE (the IE corresponding to a sub-parameter) is not configured in the DRX short-cycle configuration parameter, and then it means that a value of a corresponding sub-parameter IE in the DRX long-cycle configuration parameter is multiplexed by the sub-parameter. Here, the IE may be an IE in the DRX configuration information.

In an example, a correspondence between DRX cycles of the different DRX cycle configuration parameters includes at least one of the following: a DRX cycle corresponding to the DRX long-cycle configuration parameter with a longer DRX cycle is X times a DRX cycle corresponding to the DRX long-cycle configuration parameter with a shorter DRX cycle, where X is a positive integer greater than or equal to 1; a DRX cycle corresponding to the DRX short-cycle configuration parameter with a longer DRX cycle is Y times a DRX cycle corresponding to the DRX short-cycle configuration parameter with a shorter DRX cycle, where Y is a positive integer greater than or equal to 1; or, a DRX cycle corresponding to the DRX long-cycle configuration parameter is Z times a DRX cycle corresponding to the DRX short-cycle configuration parameter, where Z is a positive integer greater than or equal to 1.

When the network-side device is configured with a plurality of DRX long-cycle configuration parameters, then DRX long cycles in the different DRX long-cycle configuration parameters may have an integer multiple relationship.

When the network-side device is configured with a plurality of DRX short-cycle configuration parameters, then DRX short cycles in the different DRX short-cycle configuration parameters may have an integer multiple relationship.

When the network-side device is configured with a DRX long-cycle configuration parameter and a plurality of DRX short-cycle configuration parameters, then a DRX long cycle in the DRX long-cycle configuration parameter may be an integer multiple of a DRX short cycle in any of the DRX short-cycle configuration parameters.

In an example, timers used by the different DRX cycle configuration parameters include at least one of the following: different DRX-onDurationTimers are used by the different DRX cycle configuration parameters; different DRX-InactivityTimers are used by the different DRX cycle configuration parameters; or, different DRX-ShortCycle Timers are used by the different DRX short-cycle configuration parameters.

Here, a timer used by each DRX cycle configuration parameter may be run independently. Here, the timer may include at least one of the following: a DRX OnDuration timer (drx-onDurationTimer); a DRX inactivity timer (DRX IAT timer); or a DRX short-cycle timer (DRX ShortCycletimer).

Taking the DRX OnDuration timer as an example, after a first DRX OnDuration timer of one DRX cycle configuration parameter starts timing, a second DRX OnDuration timer of another DRX cycle configuration parameter operates independently based on its own start position and timing duration, and the first DRX OnDuration timer is not reset because it reaches the timing start position of the second DRX OnDuration timer.

In an example, timers used by the different DRX cycle configuration parameters include at least one of the following: a same DRX-onDuration Timer is used by the different DRX cycle configuration parameters; a same DRX-InactivityTimer is used by the different DRX cycle configuration parameters; or, a same DRX-ShortCycleTimer is used by the different DRX cycle configuration parameters.

Here, for timers of the same type, a plurality of DRX cycle configuration parameters may be shared.

Taking the DRX OnDuration timer as an example, one DRX OnDuration timer may be shared by a plurality of DRX cycle configuration parameters. The DRX OnDuration timer may be started when the start position of the DRX OnDuration timer of the first DRX cycle configuration parameter is reached. In a timing process of the DRX OnDuration timer, the DRX duration timer may restart timing based on a timing duration of the second DRX cycle configuration parameter if the start position of the DRX OnDuration timer of the second DRX cycle configuration parameter is reached.

For example, a plurality of DRX cycle configuration parameters may share a DRX OnDuration timer, and a timing starting point and timing duration of the DRX OnDuration timer may be determined to respective DRX cycle configuration parameters: e.g., three DRX cycle configuration parameters are configured: DRX cycle configuration parameter 1: cycle=20 ms, DRX cycle configuration parameter 2: cycle=25 ms, and DRX cycle configuration parameter 3: cycle=16 ms. The drx-SlotOffset, i.e., delays before the DRX OnDuration timer (drx-onDurationTimer) is started, is the same, it is assumed that they are all 0; and then it is assumed that OnDuration=8 ms. Then a terminal will start the drx-on DurationTimer at 0, 20, and 40, i.e., run an OnDuration duration assignment in the DRX cycle configuration parameter 1. At the same time the drx-onDurationTimer is started at 25, 50, and 75, i.e., an OnDuration duration assignment in the DRX cycle configuration parameter 2 is run. At the same time the drx-onDurationTimer is started at 16, 32, and 48, i.e., an OnDuration duration assignment in the DRX cycle configuration parameter 3 is run.

As shown in FIG. 5, a point pointed to by an arrow is a point at which the drx-onDurationTimer is restarted.

In an example, the numbers of duration cycles of drx-ShortCycleTimers used by different DRX short-cycle configuration parameters are different.

For example, e.g., it runs 10 cycles for the DRX short-cycle configuration parameter 1 and stops; e.g., it runs 10 cycles for the DRX short-cycle configuration parameter 2 and stops; e.g., it runs 15 cycles for the DRX short-cycle configuration parameter 3 and stops.

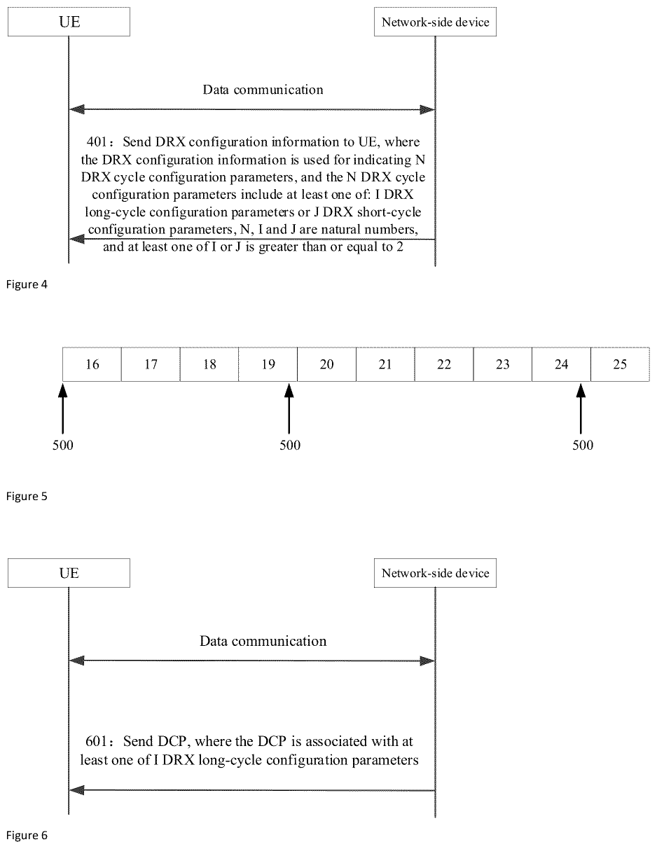

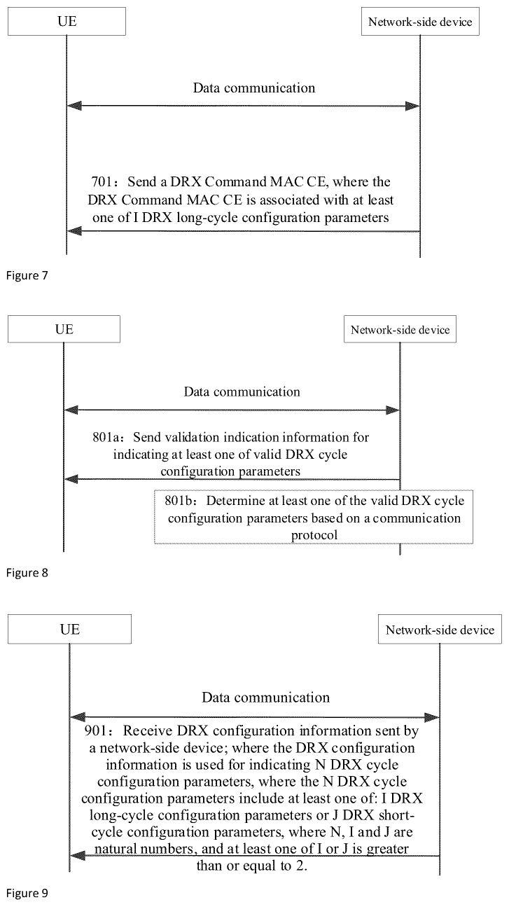

As shown in FIG. 6, an example of the disclosure provides a method for transmitting information, performed by a network-side device, including step 601.

Step 601: DCP is sent, where the DCP is associated with at least one of the I DRX long-cycle configuration parameters.

Step 601 may be implemented alone or in conjunction with step 401.

A role of the DCI with CRC scrambled by PS-RNTI (DCP) is to inform the UE whether a PDCCH needs to be monitored during OnDuration. That is, the DCP may indicate whether OnDuration is turned on, and the UE may determine whether to monitor the PDCCH according to an indication of the DCP.

Here, the DCP may be used for informing the UE whether the PDCCH needs to be monitored during OnDuration in one or more DRX long-cycle configuration parameters. That is, the DCP may be associated with one or more DRX long-cycle configuration parameters.

In an example, the DRX long-cycle configuration parameter associated with the DCP is specified by a communication protocol; or, the DRX long-cycle configuration parameter associated with the DCP is determined by indication information sent by the network-side device.

The DRX long-cycle configuration parameter associated with the DCP may be specified by the communication protocol and/or indicated by the indication information sent to the UE by the network-side device.

For example, the network-side device may notify, via the indication information at the time of a DCP configuration, the UE in advance of a range of DRX long-cycle configuration parameters to which the DCP is applicable.

In an implementation, the indication information that indicates the DRX long-cycle configuration parameter associated with the DCP may be carried in the DCP.

For example, the network-side device may notify, in the indication information carried in the DCP, the UE of a range of DRX long-cycle configuration parameters to which the DCP is applicable.

In an example, a monitoring start position of the DCP is associated with one of the I DRX long-cycle configuration parameters.

In an implementation, if a plurality of sets of DRX long-cycle configuration parameters are configured, the monitoring start position of the DCP may refer to one of the sets of DRX long-cycle configuration parameters. That is, the monitoring start position of the DCP may refer to one of a plurality of DRX long-cycle configuration parameters.

For example, the monitoring start position of the DCP may be located in a slot before one of the plurality of DRX long-cycle configuration parameters.

In an example, the DRX long-cycle configuration parameter associated with the monitoring start position of the DCP is specified by a communication protocol; or, the DRX long-cycle configuration parameter associated with the monitoring start position of the DCP is indicated by the network-side device.

The DRX long-cycle configuration parameter to which the DCP refers may be specified by the communication protocol in advance or notified to the UE by the network-side device.

For example, the network-side device may notify, at the time of the DCP configuration, the UE in advance of the DRX long-cycle configuration parameter to which the DCP refers.

As an example, it is agreed that a first set of configured DRX long-cycle configuration parameters is a reference for the DCP.

As shown in FIG. 7, an example of the disclosure provides a method for transmitting information, performed by a network-side device, including step 701.

Step 701: a DRX Command MAC CE is sent, where the DRX Command MAC CE is associated with at least one of I DRX long-cycle configuration parameters.

Step 701 may be implemented alone or in conjunction with at least one of step 401 or step 601.

The discontinuous reception (DRX) command medium access control control element (DRX Command MAC CE) is used for indicating a terminal device to perform discontinuous reception adopting a short cycle.

The DRX Command MAC CE may be associated with one or more DRX long-cycle configuration parameters. When the DRX Command MAC CE is received by the UE, a timer of the associated DRX long-cycle configuration parameter may be stopped, such as: a DRX OnDuration timer and a DRX inactivity timer (DRX IAT timer). A DRX short-cycle configuration parameter is then started.

As an example: if a plurality of DRX cycles do not adopt an independent DRX OnDuration timers or DRX IAT timer, i.e. a common DRX OnDuration timer or DRX IAT timer is used and turned on to record monitoring of a duration or monitoring when a new authorization is received. At this point, if the DRX Command MAC CE is received, it means to stop the common DRX OnDuration timer or DRX IAT timer.

As an example, after this common DRX OnDuration timer or DRX IAT timer is stopped, a DRX short cycle is entered.

As an example: if a plurality of DRX cycles adopt an independent DRX OnDuration timer or DRX IAT timer, i.e. a respective DRX OnDuration timer or DRX IAT timer is used and turned on to record monitoring of the duration or monitoring when the new authorization is received. At this point, if the DRX Command MAC CE is received, it means to stop this running DRX OnDuration timer or DRX IAT timer. At this point, a DRX long cycle corresponding to this running DRX OnDuration timer or DRX IAT timer may be invalid; while other DRX long cycles may continue to be valid.

As shown in FIG. 8, an example of the disclosure provides a method for transmitting information, performed by a network-side device, including at least one of step 801a or step 801b.

Step 801a: validation indication information is sent for indicating at least one of the valid DRX cycle configuration parameters; or Step 801b: at least one of the valid DRX cycle configuration parameters is determined based on a communication protocol.

At least one of step 801a or step 801b may be implemented alone or in conjunction with at least one of: step 401, step 601 or step 701.

The DRX cycle configuration parameter indicated by the DRX configuration information may be the valid DRX cycle configuration parameter by default or a non-valid DRX cycle configuration parameter by default.

Validation indication information may be sent to the UE by the network-side device to indicate the valid DRX cycle configuration parameter; and the valid DRX cycle configuration parameter may also be determined by the network-side device and the UE according to a specification of a communication protocol. For example, the communication protocol may specify that a first DRX cycle configuration parameter indicated by the DRX configuration information is the valid DRX cycle configuration parameter.

In an implementation, the validation indication information may be used for indicating at least one of the de-validated DRX cycle configuration parameters.

In an example, sending the validation indication information includes at least one of the following: a radio resource control (RRC) message carrying the validation indication information is sent; downlink control information (DCI) carrying the validation indication information is sent; or, a medium access control control element (MAC CE) carrying the validation indication information is sent.

In an implementation, the network side may indicate a plurality of DRX cycle configuration parameters (e.g., DRX long-cycle configuration parameters) via DRX configuration information carried in the RRX message, and then the network-side device may indicate the UE to use 1 or more of these sets of DRX cycle configuration parameters via the validation indication information carried in the DCI.

In an implementation, the network side may indicate a plurality of DRX cycle configuration parameters (e.g., DRX long-cycle configuration parameters) via DRX configuration information carried in the RRX message, and then the network-side device may indicate the UE to use 1 or more of these sets of DRX cycle configuration parameters via the validation indication information carried in the MAC CE.

In an implementation, if a Long DRX Command MAC CE is received, at this point the DRX short cycle will be stopped and the long cycle will be entered, and a valid DRX long-cycle configuration may be carried in this MAC CE at this point. That is, the DRX configuration information that indicates a plurality of DRX cycle configuration parameters (e.g., DRX long cycle configuration parameters) may be carried in the Long DRX Command MAC CE.

In an implementation, 3 sets of DRX cycle configuration parameters are currently running. The network-side device may indicate to keep one set of DRX cycle configuration parameters to be validated via the validation indication information carried in the MAC CE, and to de-enable (de-validate) other DRX cycle configuration parameters, and the validation indication information may further validate a fourth set of DRX cycle configuration parameters.

In an implementation, the valid DRX long-cycle configuration parameter may be agreed based on a protocol. For example, the drx-ShortCycleTimer enters a long cycle after timing out, at which point the valid DRX long-cycle configuration parameter is agreed based on the protocol, such as configured I sets of all long-cycle parameters.

Corresponding to the foregoing examples on the side of the network-side device, an example of the disclosure further proposes a method for transmitting information performed by UE. It needs to be noted that the method corresponds to the foregoing examples on the side of the network-side device, e.g., the network-side device and the UE need to enter or stop a DRX cycle at the same time to maintain synchronization, and settings for a timer and the like are all implemented synchronously. Thus, the same explanations or features will not be repeated, and a reference may be made to the foregoing examples.

As shown in FIG. 9, an example of the disclosure provides a method for transmitting information, performed by UE, including step 901.

Step 901: DRX configuration information sent by a network-side device is received; where the DRX configuration information is used for indicating N DRX cycle configuration parameters, where the N DRX cycle configuration parameters include at least one of: I DRX long-cycle configuration parameters or J DRX short-cycle configuration parameters, where N, I and J are natural numbers, and at least one of I or J is greater than or equal to 2.

Here, the network-side device may be an access network device such as a base station, or a core network device.

In an implementation, the DRX configuration information may be determined and sent to the UE by the access network device.

In an implementation, the DRX configuration information may be determined by the core network device and sent to the UE by the access network device.

The DRX cycle configuration parameters may be a set of DRX cycle configuration parameters associated with a DRX cycle, and a DRX cycle configuration parameter may be composed of a plurality of sub-parameters.

For example, the DRX cycle configuration parameters may include, but are not limited to, the following sub-parameters: cycle (i.e., DRX Cycle), OnDuration duration, discontinuous reception inactivity timer (DRX Inactivitytimer, DRX IAT timer) duration, drx-SlotOffset (i.e., a delay before a drx-onDurationTimer is started), and drx-StartOffset (i.e. start offset). For a DRX long cycle, the configuration parameters may further include: Long DRX Cycle, etc.; and the DRX short-cycle configuration parameters may further include: Short DRX Cycle, and short-cycle duration (drx-ShortCycleTimer).

In an implementation, DRX cycles are different in different DRX cycle configuration parameters. Here, the DRX cycles may include at least one of: long DRX cycles or short DRX cycles.

The network-side device may configure at least one of: a plurality of DRX long-cycle configuration parameters or a plurality of DRX short-cycle configuration parameters, which are used for meeting demands of different services, e.g., an XR service, for data transmission cycles.

For example, when a data transmission cycle is shorter, transmission may be performed using an OnDuration period in a DRX cycle configuration parameter with a shorter cycle, and thus a case of a data transmission delay due to a longer cycle of a DRX cycle is reduced. A service real-time performance is improved.

In an implementation, the network-side device may configure a plurality of DRX long-cycle configuration parameters and a DRX short-cycle configuration parameter.

In an implementation, the network-side device may configure a DRX long-cycle configuration parameter and a plurality of DRX short-cycle configuration parameters.

In an implementation, the network-side device may configure a plurality of DRX long-cycle configuration parameters and not configure DRX short-cycle configuration parameters.

In an implementation, receiving the discontinuous reception (DRX) configuration information sent by the network-side device includes at least one of the following: receiving a radio resource control (RRC) message carrying the DRX configuration information sent by the network-side device; receiving downlink control information (DCI) carrying the DRX configuration information sent by the network-side device; or, receiving a medium access control control element (MAC CE) carrying the DRX configuration information sent by the network-side device.

The DRX configuration information may be used for indicating sub-parameters of a DRX cycle configuration parameter, or, a piece of DRX configuration information may be used for indicating a sub-parameter of a DRX cycle configuration parameter, or, a piece of DRX configuration information may be used for indicating all sub-parameters of n DRX cycle configuration parameters, where n is a positive integer less than or equal to N. The number of sub-parameters that a piece of DRX configuration information may indicate is not limited here.

In an implementation, each of the plurality of pieces of DRX configuration information sent to the UE by the network-side device may indicate a sub-parameter of the DRX cycle configuration parameter. A plurality of pieces of DRX configuration information may be sent to the UE by the network-side device through single signaling, and a plurality of pieces of DRX configuration information may be sent to the UE by the network-side device through a plurality of pieces of signaling, which is not limited by this example here.

For example, a DRX cycle configuration parameter (DRX long-cycle configuration parameter or DRX short cycle configuration parameter) may correspond to a plurality of pieces of DRX configuration information, and the plurality of pieces of DRX configuration information each indicates a sub-parameter of the DRX cycle. Each piece of DRX configuration information may be carried by an informatica element (IE).

In this way, by configuring the plurality of DRX cycle configuration parameters, DRX meets cycle changes of different service data transmission, a data transmission delay generated due to the inconsistency between a service data transmission cycle and the DRX cycle is reduced, a data transmission demand is met while UE power is saved, and data transmission efficiency is improved.

In an example, the different DRX configuration information is used for indicating sub-parameters in the different DRX cycle configuration parameters.

Here, sub-parameters of the different DRX cycle configuration parameters may be configured separately adopting different DRX configuration information. That is, the DRX configuration parameters include first information, and the first information is used for indicating a sub-parameter specific to each of the DRX cycle configuration parameters respectively. The first information is used for indicating sub-parameters in different DRX short-cycle configurations. That is, sub-parameters in different DRX short-cycle configurations are indicated by different first information.

In an implementation, a piece of DRX configuration information is used for indicating a DRX cycle configuration parameter, and DRX configuration information corresponding to different DRX cycles is different.

In an implementation, a piece of DRX configuration information is used for indicating a sub-parameter of a configuration parameter of a DRX cycle, and DRX configuration information of different sub-parameters is different.

In an implementation, configuration parameters of different DRX cycles may be the same or different.

For example, DRX configuration information of each DRX cycle configuration parameter occupies an independent IE.

For example, a network side may configure at least one of: two sets of DRX long-cycle configuration parameters or two sets of DRX short-cycle configuration parameters, DRX configuration information of each set of DRX long-cycle configuration parameters occupies an independent IE, and DRX configuration information of each set of DRX short-cycle configuration parameters occupies an independent IE.

Specific configurations are as follows.
A first set of DRX long-cycle configuration parameters: duration of cycle 1, OnDuration duration 1, and discontinuous reception inactivity timer (DRX Inactivitytimer, DRX IAT timer) duration 1 . . .
A second set of DRX long-cycle configuration parameters: cycle 2, OnDuration duration 2, DRX IAT timer duration 2 . . .
A first set of DRX short-cycle configuration parameters: cycle 1, OnDuration duration 1, DRX IAT timer duration 1; short-cycle duration (drx-ShortCycleTimer) 1 . . .
A second set of DRX short-cycle configuration parameters: cycle 2, OnDuration duration 2, DRX IAT timer duration 2; short-cycle duration (drx-ShortCycleTimer) 2 . . .

In an example, one piece of the DRX configuration information is used for indicating sub-parameters of the same type in the plurality of DRX cycle configuration parameters.

The DRX configuration parameters include second information, and the second information is used for indicating a common sub-parameter of the M DRX cycle configuration parameters, where M is a positive integer less than or equal to N.

Here, a piece of second information may be used for indicating sub-parameters of a same type in the M DRX cycle configuration parameters, where M is a positive integer less than or equal to N.

Here, sub-parameters of the same type in a plurality of DRX cycle configuration parameters (at least one of DRX long-cycle configuration parameters or DRX short cycle configuration parameters) may share (multiplex) one or more pieces of DRX configuration information. That is, a plurality of DRX cycle configuration parameters adopt sub-parameters indicated by the same piece of DRX configuration information. Here, a piece of DRX configuration information may indicate one or more sub-parameters.

For example, the network side may configure at least one of: two sets of DRX long-cycle configuration parameters or two sets of DRX short-cycle configuration parameters, where some of sub-parameters may be multiplexed, i.e., the multiplexed sub-parameters may be common to a plurality of sets of configurations, and other sub-parameters are configured separately. Specific configurations are as follows.
A first set of DRX long-cycle configuration parameters: cycle 1, . . .
A second set of DRX long-cycle configuration parameters: cycle 2, . . .
A first set of DRX short-cycle configuration parameters: cycle 1, short-cycle duration (drx-ShortCycleTimer) 1 . . .
A second set of DRX short-cycle configuration parameters: cycle 2, short-cycle duration (drx-ShortCycleTimer) 2 . . .

The above sub-parameters are indicated by the respective DRX configuration information corresponding to each DRX cycle configuration parameter, and other sub-parameters such as OnDuration duration and DRX IAT timer duration may be indicated by the multiplexed DRX configuration information. The multiplexed DRX configuration information may indicate sub-parameters of one or more types. The multiplexed DRX configuration information may be sent separately. The multiplexed DRX configuration information may also belong to a predetermined DRX cycle, and other DRX cycles may multiplex the multiplexed DRX configuration information of this predetermined DRX cycle.

In an example, the DRX configuration information corresponding to a sub-parameter in the DRX long-cycle configuration parameters is used for indicating a sub-parameter in the DRX short-cycle configuration parameters.

For example, the network side may configure DRX long-cycle configuration parameters and DRX short-cycle configuration parameters, where a DRX short cycle may multiplex some of sub-parameters of a DRX long cycle, i.e., DRX configuration information of the DRX long-cycle configuration parameters may be used for indicating sub-parameters in the DRX short-cycle configuration parameters. Specific configurations are as follows.
A first set of DRX long-cycle configuration parameters: cycle 1, OnDuration duration 1 . . .
A second set of DRX long-cycle configuration parameters: cycle 2, OnDuration duration 1 . . .
A first set of DRX short-cycle configuration parameters: cycle 1, short-cycle duration (drx-ShortCycleTimer) 1 . . .
A second set of DRX short-cycle configuration parameters: cycle 2, short-cycle duration (drx-ShortCycleTimer) 2 . . .

The above sub-parameters may be indicated by DRX configuration information corresponding to each DRX cycle configuration parameter respectively. Other sub-parameters such as OnDuration duration and DRX IAT timer duration may be indicated by the DRX long-cycle configuration parameters. That is, one or more sub-parameters in the DRX short-cycle configuration parameters may multiplex one or more sub-parameters in the DRX long-cycle configuration parameters.

In an example, in response to that a sub-parameter of a first DRX cycle configuration parameter of the N DRX cycle configuration parameters does not have the corresponding DRX configuration information, the sub-parameter of the first DRX cycle configuration parameter is determined in at least one of the following modes: the sub-parameter of the first DRX cycle configuration parameter is specified by a communication protocol; the sub-parameter of the first DRX cycle configuration parameter is a preset value; or, the sub-parameter of the first DRX cycle configuration parameter is indicated by the DRX configuration information of a second DRX cycle configuration parameter of the N DRX cycle configuration parameters.

Here, the DRX configuration information of the first DRX cycle configuration parameter may not directly indicate one or more sub-parameters in the first DRX cycle configuration parameter so as to reduce the amount of data of the DRX configuration information and save signaling overhead.

The DRX configuration information of the first DRX cycle configuration parameter does not directly indicate one or more sub-parameters in the first DRX cycle configuration parameter, and may be specified by a communication protocol to take a value, or, may take a preset value (e.g., a default value).

One or more sub-parameters in the first DRX cycle configuration parameter are not directly indicated by the DRX configuration information of the first DRX cycle configuration parameter, but may also be indicated by the DRX configuration information of the second DRX cycle configuration parameter, i.e., the DRX configuration information of the second DRX cycle configuration parameter may be multiplexed for the one or more sub-parameters of the first DRX cycle configuration parameter.

In an implementation, there may be one or more of first DRX cycle configuration parameters.

For example, the network side is configured with two DRX cycle configuration parameters, where a certain IE (the IE corresponding to a sub-parameter) is not configured in the second DRX cycle configuration parameter, and then it means that a value of a corresponding sub-parameter IE in the first DRX cycle configuration parameter is multiplexed. Here, the IE may be an IE in the DRX configuration information.

Alternatively, a certain IE (the IE corresponding to a sub-parameter) is not configured in the second DRX cycle configuration parameter, and then it means that a default value is taken or a value is agreed by a protocol. Here, the IE may be an IE in the DRX configuration information.

In an example, the first DRX cycle configuration parameter is a DRX short-cycle configuration parameter, and the second DRX cycle configuration parameter is a DRX long-cycle configuration parameter.

For example, the network side is configured with a DRX long-cycle configuration parameter and a DRX short-cycle configuration parameter, where a certain IE (the IE corresponding to a sub-parameter) is not configured in the DRX short-cycle configuration parameter, and then it means that a value of a corresponding sub-parameter IE in the DRX long-cycle configuration parameter is multiplexed by the sub-parameter. Here, the IE may be an IE in the DRX configuration information.

In an example, a correspondence between DRX cycles of the different DRX cycle configuration parameters includes at least one of the following: a DRX cycle corresponding to the DRX long-cycle configuration parameter with a longer DRX cycle is X times a DRX cycle corresponding to the DRX long-cycle configuration parameter with a shorter DRX cycle, where X is a positive integer greater than or equal to 1; a DRX cycle corresponding to the DRX short-cycle configuration parameter with a longer DRX cycle is Y times a DRX cycle corresponding to the DRX short-cycle configuration parameter with a shorter DRX cycle, where Y is a positive integer greater than or equal to 1; or, a DRX cycle corresponding to the DRX long-cycle configuration parameter is Z times a DRX cycle corresponding to the DRX short-cycle configuration parameter, where Z is a positive integer greater than or equal to 1.

When the network-side device is configured with a plurality of DRX long-cycle configuration parameters, then DRX long cycles in the different DRX long-cycle configuration parameters may have an integer multiple relationship.

When the network-side device is configured with a plurality of DRX short-cycle configuration parameters, then DRX short cycles in the different DRX short-cycle configuration parameters may have an integer multiple relationship.

When the network-side device is configured with a DRX long-cycle configuration parameter and a plurality of DRX short-cycle configuration parameters, then a DRX long cycle in the DRX long-cycle configuration parameter may be an integer multiple of a DRX short cycle in any of the DRX short-cycle configuration parameters.

In an example, timers used by the different DRX cycle configuration parameters include at least one of the following: different DRX-onDurationTimers are used by the different DRX cycle configuration parameters; different DRX-InactivityTimers are used by the different DRX cycle configuration parameters; or, different DRX-ShortCycle Timers are used by different DRX short-cycle configuration parameters.

Here, a timer used by each DRX cycle configuration parameter may be run independently. Here, the timer may include at least one of the following: a DRX OnDuration timer (drx-onDurationTimer); a DRX inactivity timer (DRX IAT timer); or a DRX short-cycle timer (DRX ShortCycletimer).

Taking the DRX OnDuration timer as an example, after a first DRX OnDuration timer of one DRX cycle configuration parameter starts timing, a second DRX OnDuration timer of another DRX cycle configuration parameter operates independently based on its own start position and timing duration, and the first DRX OnDuration timer is not reset because it reaches the timing start position of the second DRX OnDuration timer.

In an example, timers used by the different DRX cycle configuration parameters include at least one of the following: a same DRX-onDurationTimer is used by different DRX cycle configuration parameters; a same DRX-InactivityTimer is used by the different DRX cycle configuration parameters; or, a same DRX-ShortCycleTimer is used by the different DRX cycle configuration parameters.

Here, for timers of the same type, a plurality of DRX cycle configuration parameters may be shared.

Taking the DRX OnDuration timer as an example, one DRX OnDuration timer may be shared by a plurality of DRX cycle configuration parameters. The DRX OnDuration timer may be started when the start position of the DRX OnDuration timer of the first DRX cycle configuration parameter is reached. In a timing process of the DRX OnDuration timer, the DRX duration timer may restart timing based on a timing duration of the second DRX cycle configuration parameter if the start position of the DRX OnDuration timer of the second DRX cycle configuration parameter is reached.

For example, a plurality of DRX cycle configuration parameters may share a DRX OnDuration timer, and a timing starting point and timing duration of the DRX OnDuration timer may be determined to respective DRX cycle configuration parameters: e.g., three DRX cycle configuration parameters are configured: DRX cycle configuration parameter 1: cycle=20 ms, DRX cycle configuration parameter 2: cycle=25 ms, DRX cycle configuration parameter 3: cycle=16 ms. The drx-SlotOffset, i.e., delays before the DRX OnDuration timer (drx-onDuration Timer) is started, is the same, it is assumed that they are all 0; and then it is assumed that OnDuration=8 ms. Then a terminal will start the drx-onDurationTimer at 0, 20, and 40, i.e., run an OnDuration duration assignment in the DRX cycle configuration parameter 1. At the same time the drx-onDurationTimer is started at 25, 50, and 75, i.e., an OnDuration duration assignment in the DRX cycle configuration parameter 2 is run. At the same time the drx-onDurationTimer is started at 16, 32, and 48, i.e., an OnDuration duration assignment in the DRX cycle configuration parameter 3 is run.

As shown in FIG. 5, a point pointed to by an arrow is a point at which the drx-on Duration Timer is restarted.

In an example, the numbers of duration cycles of drx-ShortCycleTimers used by different DRX short-cycle configuration parameters are different.

For example, e.g., it runs 10 cycles for the DRX short-cycle configuration parameter 1 and stops; e.g., it runs 10 cycles for the DRX short-cycle configuration parameter 2 and stops; e.g., it runs 15 cycles for the DRX short-cycle configuration parameter 3 and stops.

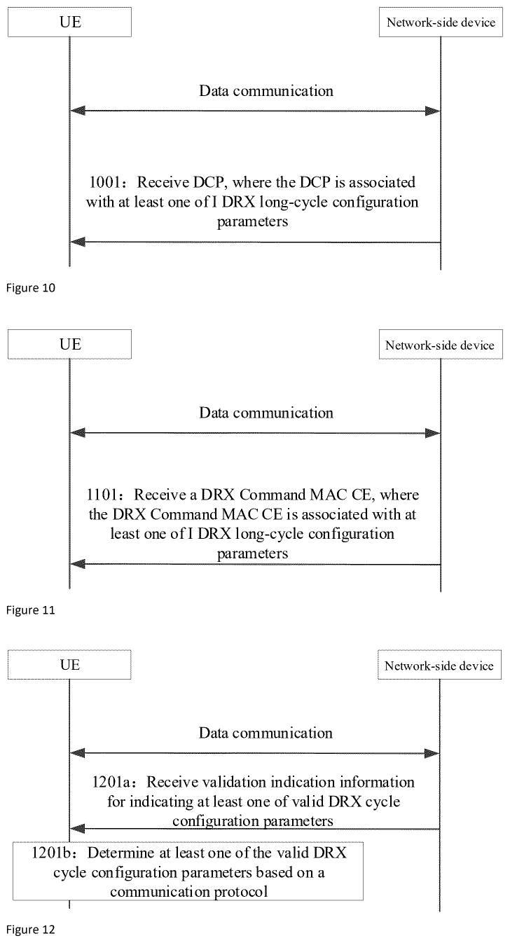

As shown in FIG. 10, an example of the disclosure provides a method for transmitting information, performed by UE, including step 1001.

Step 1001: DCP is received, where the DCP is associated with at least one of the I DRX long-cycle configuration parameters.

Step 1001 may be implemented alone or in conjunction with step 901.

A role of the DCI with CRC scrambled by PS-RNTI (DCP) is to inform the UE whether a PDCCH needs to be monitored during OnDuration. That is, the DCP may indicate whether OnDuration is turned on, and the UE may determine whether OnDuration according to an indication of the DCP.

Here, the DCP may be used for informing the UE whether the PDCCH needs to be monitored during OnDuration in one or more DRX long-cycle configuration parameters. That is, the DCP may be associated with one or more DRX long-cycle configuration parameters.

In an example, the DRX long-cycle configuration parameter associated with the DCP is specified by a communication protocol; or, the DRX long-cycle configuration parameter associated with the DCP is determined by indication information sent by the network-side device.

The DRX long-cycle configuration parameter associated with the DCP may be specified by the communication protocol and/or indicated by the indication information sent to the UE by the network-side device.

For example, the network-side device may notify, via the indication information at the time of a DCP configuration, the UE in advance of a range of DRX long-cycle configuration parameters to which the DCP is applicable.

In an implementation, the indication information that indicates the DRX long-cycle configuration parameter associated with the DCP may be carried in the DCP.

For example, the network-side device may notify, in the indication information carried in the DCP, the UE of a range of DRX long-cycle configuration parameters to which the DCP is applicable.

In an example, a monitoring start position of the DCP is associated with one of the I DRX long-cycle configuration parameters.

In an implementation, if a plurality of sets of DRX long-cycle configuration parameters are configured, the monitoring start position of the DCP may refer to one of the sets of DRX long-cycle configuration parameters. That is, the monitoring start position of the DCP may refer to one of a plurality of DRX long-cycle configuration parameters.

For example, the monitoring start position of the DCP may be located in a slot before one of the plurality of DRX long-cycle configuration parameters.

In an example, the DRX long-cycle configuration parameter associated with the monitoring start position of the DCP is specified by a communication protocol; or, the DRX long-cycle configuration parameter associated with the monitoring start position of the DCP is indicated by the network-side device.

The DRX long-cycle configuration parameter to which the DCP refers may be specified by the communication protocol in advance or notified to the UE by the network-side device.

For example, the network-side device may notify, at the time of the DCP configuration, the UE in advance of the DRX long-cycle configuration parameter to which the DCP refers.

As an example, it is agreed that a first set of configured DRX long-cycle configuration parameters is a reference for the DCP.

As shown in FIG. 11, an example of the disclosure provides a method for transmitting information, performed by a network-side device, including step 1101.

Step 1101: a DRX Command MAC CE is received, where the DRX Command MAC CE is associated with at least one of I DRX long-cycle configuration parameters.

Step 1101 may be implemented alone or in conjunction with at least one of step 901 or step 1001.

The discontinuous reception (DRX) command medium access control control element (DRX Command MAC CE) is used for indicating a terminal device to perform discontinuous reception adopting a short cycle.

The DRX Command MAC CE may be associated with one or more DRX long-cycle configuration parameters. When the DRX Command MAC CE is received by the UE, a timer of the associated DRX long-cycle configuration parameter may be stopped, such as: a DRX OnDuration timer and a DRX inactivity timer (DRX IAT timer). A DRX short-cycle configuration parameter is then started.

As an example: if a plurality of DRX cycles do not adopt an independent DRX OnDuration timers or DRX IAT timer, i.e. a common DRX OnDuration timer or DRX IAT timer is used and turned on to record monitoring of a duration or monitoring when a new authorization is received. At this point, if the DRX Command MAC CE is received, it means to stop this common DRX OnDuration timer or DRX IAT timer.

As an example, after this common DRX OnDuration timer or DRX IAT timer is stopped, a DRX short cycle is entered.

As an example: if a plurality of DRX cycles adopt an independent DRX OnDuration timer or DRX IAT timer, i.e. a respective DRX OnDuration timer or DRX IAT timer is used and turned on to record monitoring of the duration or monitoring when the new authorization is received. At this point, if the DRX Command MAC CE is received, it means to stop this running DRX OnDuration timer or DRX IAT timer. At this point, a DRX long cycle corresponding to this running DRX OnDuration timer or DRX IAT timer may be invalid; while other DRX long cycles may continue to be valid.

As shown in FIG. 12, an example of the disclosure provides a method for transmitting information, performed by UE, including at least one of step 1201a or step 1201b.
Step 1201a: validation indication information is received for indicating at least one of the valid DRX cycle configuration parameters; or
Step 1201b: at least one of the valid DRX cycle configuration parameters is determined based on a communication protocol.

At least one of step 1201a or step 1201b may be implemented alone or in conjunction with at least one of step 901, step 1001 or step 1101.

The DRX cycle configuration parameter indicated by the DRX configuration information may be the valid DRX cycle configuration parameter by default or a non-valid DRX cycle configuration parameter by default.

Validation indication information may be sent to the UE by the network-side device to indicate the valid DRX cycle configuration parameter; and the valid DRX cycle configuration parameter may also be determined by the network-side device and the UE according to a specification of a communication protocol. For example, the communication protocol may specify that a first DRX cycle configuration parameter indicated by the DRX configuration information is the valid DRX cycle configuration parameter.

In an implementation, the validation indication information may be used for indicating at least one of the de-validated DRX cycle configuration parameters.

In an example, the receiving validation indication information includes at least one of the following: receiving a radio resource control (RRC) message carrying the validation indication information; receiving downlink control information (DCI) carrying the validation indication information; or, receiving a medium access control control element (MAC CE) carrying the validation indication information.

In an implementation, the network side may indicate a plurality of DRX cycle configuration parameters (e.g., DRX long-cycle configuration parameters) via DRX configuration information carried in the RRX message, and then the network-side device may indicate the UE to use 1 or more of these sets of DRX cycle configuration parameters via the validation indication information carried in the DCI.

In an implementation, the network side may indicate a plurality of DRX cycle configuration parameters (e.g., DRX long-cycle configuration parameters) via DRX configuration information carried in the RRX message, and then the network-side device may indicate the UE to use 1 or more of these sets of DRX cycle configuration parameters via the validation indication information carried in the MAC CE.

In an implementation, if a Long DRX Command MAC CE is received, at this point the DRX short cycle will be stopped and the long cycle will be entered, and a valid DRX long-cycle configuration may be carried in this MAC CE at this point. That is, the DRX configuration information that indicates a plurality of DRX cycle configuration parameters (e.g., DRX long cycle configuration parameters) may be carried in the Long DRX Command MAC CE.

In an implementation, 3 sets of DRX cycle configuration parameters are currently running. The network-side device may indicate to keep one set of DRX cycle configuration parameters to be validated via the validation indication information carried in the MAC CE, and to de-enable (de-validate) other DRX cycle configuration parameters, and the validation indication information may further validate a fourth set of DRX cycle configuration parameters.

In an implementation, the valid DRX long-cycle configuration parameter may be agreed based on a protocol. For example, the drx-ShortCycleTimer enters a long cycle after timing out, at which point the valid DRX long-cycle configuration parameter is agreed based on the protocol, such as configured I sets of all long-cycle parameters.

To further explain any example of the disclosure, a specific example is provided.
1. A method for configuring a plurality of sets of DRX cycle configuration parameters (including DRX long-cycle configuration parameters or DRX short-cycle configuration parameters) in a connected state is protected.
2. The plurality of sets of DRX cycle configuration parameters are configured.
a) As an example: a network may configure a plurality of sets of DRX long-cycle configuration parameters and a set of DRX short-cycle configuration parameters.
b) As an example: the network may configure a set of DRX long-cycle configuration parameters and a plurality of sets of DRX short-cycle configuration parameters.
3. Rules for configuring the plurality of sets of DRX cycle configuration parameters are as follows.
a) As an example: the plurality of sets of DRX cycle configuration parameters may be configured separately, and parameters (i.e., sub-parameters) in the DRX cycle configuration parameters include: cycle (i.e., DRX Cycle), OnDuration duration, discontinuous reception inactivity timer (DRX Inactivitytimer, DRX IAT timer) duration, drx-SlotOffset (i.e., a delay before a drx-onDurationTimer is started), and drx-StartOffset (i.e. start offset); and for a DRX long cycle, the configuration parameters may further include: Long DRX Cycle, etc.; and the DRX short-cycle configuration parameters may further include: Short DRX Cycle, and short-cycle duration (drx-ShortCycle Timer).
A first set of DRX long-cycle configuration parameters: cycle 1, OnDuration duration 1, DRX IAT timer duration 1 . . .
A second set of DRX long-cycle configuration parameters: cycle 2, OnDuration duration 2, DRX IAT timer duration 2 . . .
A first set of DRX short cycles: cycle 1, OnDuration duration 1, DRX IAT timer duration 1; short-cycle duration (drx-ShortCycleTimer) 1 . . .
A second set of DRX short cycles: cycle 2, OnDuration duration 2, DRX IAT timer duration 2; short-cycle duration (drx-ShortCycleTimer) 2 . . .

Here, separate configurations are that the DRX cycle configuration parameters are configured with independent IEs, which may have the same or different parameter values.
b) As an example: some of the parameters (sub-parameters) of the plurality of sets of DRX cycle configuration parameters may be multiplexed; that is, the multiplexed parameters may be common to a plurality of sets of configurations, and other parameters are configured separately. For example:
a first set of DRX long-cycle configuration parameters: cycle 1 . . .
a second set of DRX long-cycle configuration parameters: cycle 2 . . .
a first set of DRX short-cycle configuration parameters: cycle 1, short-cycle duration (drx-ShortCycleTimer) 1;
a second set of DRX short-cycle configuration parameters: cycle 2, short-cycle duration (drx-ShortCycleTimer) 2; and
other parameters (sub-parameters) such as OnDuration duration and DRX IAT timer duration, may be multiplexed by a plurality of sets of DRX short-cycle configuration parameters, i.e., they may be DRX short-cycle configuration parameters or multiplexed as DRX long-cycle configuration parameters (e.g., as stated in c)).
c) As an example: some parameters (sub-parameters) in the DRX short-cycle configuration parameters may multiplex parameters (sub-parameters) in the DRX long-cycle configuration parameters.

For example: OnDuration and DRX IAT timer duration in the DRX short-cycle configuration parameters are configured and multiplexed in the DRX long-cycle configuration parameters.
d) As an example: the plurality of DRX cycle configuration parameters adopt an incremental configuration in order to save signaling.

As an example, a certain IE is not configured in the second set of DRX cycle configuration parameters, and then it means that a value of a corresponding IE in the first set of DRX cycle configuration parameters is multiplexed.

Alternatively, a certain IE is not configured in the second set of DRX cycle configuration parameters, and then it means that a default value is taken or a value is agreed by a protocol.

Alternatively, a certain IE is not configured in the DRX short-cycle configuration parameter, and then it means that a DRX long-cycle configuration parameter is multiplexed.
e) As an example: if a plurality of sets of DRX long-cycle configuration parameters are configured, then DRX cycles in the DRX long-cycle configuration parameters have an integer multiple relationship with one another.

As an example: if a plurality of sets of DRX short-cycle configuration parameters are configured, then DRX cycles in the DRX short-cycle configuration parameters are in an integer multiple relationship with one another.

As an example: if a set of DRX long-cycle configuration parameters and a plurality of sets of DRX short-cycle configuration parameters are configured, a DRX cycle of the DRX long-cycle configuration parameters and a DRX cycle of any one of the DRX short-cycle configuration parameters are in an integer multiple relationship with each other.
4. A running mechanism for the plurality of sets of DRX cycle configuration parameters is as follows.
a) As an example: at least one of drx-onDurationTimers or DRX IAT timers run for respective DRX, i.e., they are a plurality of sets of timers, and a duration during which UE is considered to be active is a collection of running durations of the plurality of sets of timers.
b) As an example: at least one of the drx-onDuration Timers, DRX IAT timers or drx-ShortCycleTimers may be shared. For example, merely one drx-onDurationTimer exists, but a starting point is performed for a cycle of each DRX cycle configuration parameter, e.g., DRX short-cycle configuration parameter 1: cycle=20 ms; DRX short-cycle configuration parameter 2: cycle=25 ms; and DRX short-cycle configuration parameter 3: cycle=16 ms. The drx-SlotOffset, i.e., delays before the drx-onDurationTimer is started, and drx-StartOffset are the same, it is assumed that they are all 0, then it is assumed that OnDuration=8 ms, then a terminal will start the drx-onDurationTimer at 0, 20, and 40, i.e., run an OnDuration duration assignment in the DRX short-cycle configuration parameter 1. At the same time the drx-onDurationTimer is started at 25, 50, and 75, i.e., an OnDuration duration assignment in the DRX short-cycle configuration parameter 2 is run. At the same time the drx-onDurationTimer is started at 16, 32, and 48, i.e., an OnDuration duration assignment in the DRX short-cycle configuration parameter 3 is run.

As shown in FIG. 5, a point pointed to by an arrow is a point at which the drx-onDurationTimer is restarted.

For a short DRX cycle as an example:
1> if the Short DRX cycle is used for a DRX group, and a configured short DRX cycle configuration, if [(SFN×10)+subframe number] modulo (drx-ShortCycle)=(drx-StartOffset) modulo (drx-ShortCycle):
2> start drx-onDurationTimer for this DRX group after drx-SlotOffset from the beginning of the subframe.

That is, if a short DRX cycle is used for a DRX group and a DRX cycle is configured, if [(SFN×10)+subframe number] modulo (drx-ShortCycle)=(drx-StartOffset) modulo (drx-ShortCycle)is met, the DRX OnDuration timer (drx-onDurationTimer) is started after a delay of drx-SlotOffset at a start position of a subframe. That is, the onduration timer is turned on for each set of onduration starting points.
c) As an example: for a plurality of sets of DRX short-cycle configuration parameters configured, running of each DRX short-cycle configuration parameter is stopped in accordance with the drx-ShortCycleTimer. For example, e.g., it runs 10 cycles for the first set of DRX short-cycle configuration parameters and stops; it runs 10 cycles for the second set of DRX short-cycle configuration parameters and stops; and it runs 15 cycles for the DRX short-cycle configuration parameter and stops.
5. After the DRX Command MAC CE is received, it will cause the DRX IAT timer and the OnDuration timer (drx-onDurationTimer) of one or all of the sets of DRX long-cycle configuration parameters to stop.

As an example: if a plurality of DRX cycles do not adopt an independent DRX OnDuration timer or DRX IAT timer, i.e. a common DRX OnDuration timer or DRX IAT timer is used and turned on to record monitoring of a duration or monitoring when a new authorization is received. At this point, if the DRX Command MAC CE is received, it means to stop this common DRX OnDuration timer or DRX IAT timer.

As an example, after this common DRX OnDuration timer or DRX IAT timer is stopped, a short cycle is entered.

As an example: if a plurality of DRX cycles adopt an independent DRX OnDuration timer or DRX IAT timer, i.e. a respective DRX OnDuration timer or DRX IAT timer is used and turned on to record monitoring of the duration or monitoring when the new authorization is received. At this point, if the DRX Command MAC CE is received, it means to stop this running DRX OnDuration timer or DRX IAT timer. At this point, a DRX long cycle corresponding to this running DRX OnDuration timer or DRX IAT timer may be invalid; while other DRX long cycles may continue to be valid.
6. A plurality of sets of running DRX long-cycle configuration parameters (i.e., valid configurations) may be notified to the UE by the RRC message, the MAC CE, the DCI, etc. or agreed to be changed by a protocol.
a) As an example, the DRX long-cycle configuration parameters may be transmitted to the UE in advance through the RRC message. After that, the UE is indicated to use one or more sets of DRX long-cycle configuration parameters by carrying indication information (validation indication information) in the DCI.
b) As an example, the DRX long-cycle configuration parameters may be transmitted to the UE in advance through the RRC message. After that, the UE is indicated to use one or more sets of DRX long-cycle configuration parameters by carrying indication information (validation indication information) in the MAC CE.

As an example, if a Long DRX Command MAC CE is received: at this point the short cycle will be stopped and the long cycle will be entered, and a valid long-cycle configuration may be carried in this MAC CE at this point.

For example, 3 sets of DRX long-cycle configuration parameters run before, and then the MAC CE is received to notify that merely one set of DRX long-cycle configuration parameters is enabled, and other sets of DRX long-cycle configuration parameters are de-enabled. Alternatively a fourth set of DRX long-cycle configuration parameters runs.
c) In an example, a valid DRX long-cycle configuration parameter may be agreed based on a protocol. For example, the drx-ShortCycleTimer enters a long cycle after timing out, at which point the valid DRX long-cycle configuration parameter is agreed based on the protocol, such as configured N sets of all long-cycle parameters.
7. If a plurality of sets of DRX long-cycle configuration parameters are configured, a DCP signal may be valid for one or more of the sets of DRX cycle configuration parameters.
a) As an example: a content carried by the DCP determines whether OnDuration of one of the sets of DRX cycle configuration parameters is turned on or not.

As an example, a set of DCP configurations is configured for each DRX cycle, i.e., a separate DCP configuration determines whether onduration of the DRX cycle is turned on.

As an example: the DCP signal may be valid merely for the first set of DRX cycle configuration parameters, i.e., according to carrying of the DCP, whether the OnDuration timer is turned on at the start point of the first set of DRX cycle configuration parameters is determined; and turning on the OnDuration at starting points of other DRX cycle configuration parameters does not need to be affected by the DCP.
b) As an example: the content carried by the DCP determines whether OnDuration of all of the plurality of sets of DRX cycle configuration parameters is turned on or not.
c) The behavior is agreed in advance by a protocol or notified by the network.

As an example, the network may notify, at the time of a DCP configuration, the UE in advance of a range of DRX cycle configuration parameters to which the DCP is applicable.

As an example, the network may notify, in related information carried in the DCP, the UE of a range of DRX cycle configuration parameters to which the DCP is applicable.
8. If a plurality of sets of DRX long-cycle configuration parameters are configured, a starting reference position of monitoring of the DCP signal will refer to a configuration of one of the sets of DRX long-cycle configuration parameters (reference DRX).
a) The reference DRX is agreed in advance by a protocol or notified by the network.

As an example, the network may notify, at the time of the DCP configuration, the UE in advance which reference DRX is for this DCP configuration.

As an example, it is agreed that a first set of DRX cycle configuration parameters is the reference DRX for configuring the DCP, as follows:
an offset by ps-Offset indicating a time, where the UE starts monitoring PDCCH for detection of DCI format 2_6 according to the number of search space sets, prior to a slot where the drx-onDuration Timer of the first configured Long DRX cycle configuration would start on the PCell or on the SpCell.

That is, ps-Offset indicates a time where the UE monitors the PDCCH for the detection of DCI formats 2-6 according to the number of search space sets, and the time is located prior to a slot where the drx-onDurationTimer of the long DRX cycle configuration configured on a PCell or SpCell will start.

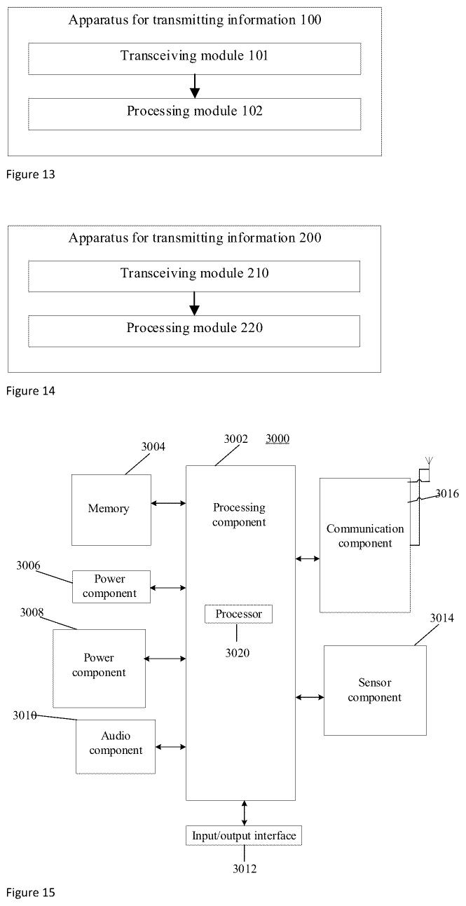

As shown in FIG. 13, an example of the disclosure provides an apparatus 100 for transmitting information, arranged in a network-side device, including a transceiving module 101[1].

The transceiving module 101[2], configured to send discontinuous reception (DRX) configuration information to user equipment (UE); where the DRX configuration information is used for indicating N DRX cycle configuration parameters, where the N DRX cycle configuration parameters include at least one of: I DRX long-cycle configuration parameters or J DRX short-cycle configuration parameters, where N, I and J are natural numbers, and at least one of I or J is greater than or equal to 2.

In an example, the different DRX configuration information is used for indicating sub-parameters in the different DRX cycle configuration parameters.

In an example, one piece of the DRX configuration information is used for indicating sub-parameters of the same type in a plurality of DRX cycle configuration parameters.

In an example, the DRX configuration information corresponding to a sub-parameter in the DRX long-cycle configuration parameters is used for indicating a sub-parameter in the DRX short-cycle configuration parameters.

In an example, in response to that a sub-parameter of a first DRX cycle configuration parameter of the N DRX cycle configuration parameters does not have the corresponding DRX configuration information, the sub-parameter of the first DRX cycle configuration parameter is determined in at least one of the following modes: the sub-parameter of the first DRX cycle configuration parameter being specified by a communication protocol; the sub-parameter of the first DRX cycle configuration parameter being a preset value; or, the sub-parameter of the first DRX cycle configuration parameter being indicated by the DRX configuration information of a second DRX cycle configuration parameter of the N DRX cycle configuration parameters.

In an example, the first DRX cycle configuration parameter is a DRX short-cycle configuration parameter, and the second DRX cycle configuration parameter is a DRX long-cycle configuration parameter.

In an example, a correspondence between DRX cycles of the different DRX cycle configuration parameters includes at least one of the following: a DRX cycle corresponding to the DRX long-cycle configuration parameter with a longer DRX cycle being X times a DRX cycle corresponding to the DRX long-cycle configuration parameter with a shorter DRX cycle, where X is a positive integer greater than or equal to 1; a DRX cycle corresponding to the DRX short-cycle configuration parameter with a longer DRX cycle being Y times a DRX cycle corresponding to the DRX short-cycle configuration parameter with a shorter DRX cycle, where Y is a positive integer greater than or equal to 1; or, a DRX cycle corresponding to the DRX long-cycle configuration parameter being Z times a DRX cycle corresponding to the DRX short-cycle configuration parameter, where Z is a positive integer greater than or equal to 1.

In an example, timers used by the different DRX cycle configuration parameters include at least one of the following: different DRX cycle configuration parameters using different DRX-onDurationTimers; the different DRX cycle configuration parameters using different DRX-InactivityTimers; or, the different DRX short-cycle configuration parameters using different DRX-ShortCycleTimers.

In an example, timers used by the different DRX cycle configuration parameters include at least one of the following: different DRX cycle configuration parameters using a same DRX-onDurationTimer; the different DRX cycle configuration parameters using a same DRX-InactivityTimer; or, the different DRX cycle configuration parameters using a same DRX-ShortCycleTimer.

In an example, the transceiving module 101 [3]is further configured to: send downlink control information with cyclic redundancy check scrambled by power saving-radio network temporary identity (DCP), where the DCP is associated with at least one of the I DRX long-cycle configuration parameters.

In an example, the DRX long-cycle configuration parameter associated with the DCP is specified by a communication protocol; or, the DRX long-cycle configuration parameter associated with the DCP is determined by indication information sent by the network-side device.

In an example, a monitoring start position of the DCP is associated with one of the I DRX long-cycle configuration parameters.

In an example, the DRX long-cycle configuration parameter associated with the monitoring start position of the DCP is specified by a communication protocol; or, the DRX long-cycle configuration parameter associated with the monitoring start position of the DCP is indicated by the network-side device.

In an example, the transceiving module 101 [4]is further configured to: send a discontinuous reception command medium access control control element (DRX Command MAC CE), where the DRX Command MAC CE is associated with at least one of the I DRX long-cycle configuration parameters.

In an example, at least one of: the transceiving module 101 [5]is further configured to: send validation indication information for indicating at least one of the valid DRX cycle configuration parameters; or, the apparatus further includes a processing module 106 [6], configured to determine at least one of the valid DRX cycle configuration parameters based on a communication protocol.

In an example, the transceiving module 101 [7] is specifically configured to perform at least one of the following: sending a radio resource control (RRC) message carrying the validation indication information; sending downlink control information (DCI) carrying the validation indication information; or, sending a medium access control control element (MAC CE) carrying the validation indication information.

As shown in FIG. 14, an example of the disclosure provides an apparatus 200 for transmitting information, arranged in a network-side device, including a transceiving module 210.

The transceiving module 210, configured to receive discontinuous reception (DRX) configuration information sent by a network-side device; where the DRX configuration information is used for indicating N DRX cycle configuration parameters, where the N DRX cycle configuration parameters include at least one of: I DRX long-cycle configuration parameters or J DRX short-cycle configuration parameters, where N, I and J are natural numbers, and at least one of I or J is greater than or equal to 2.

In an example, the different DRX configuration information is used for indicating sub-parameters in the different DRX cycle configuration parameters.

In an example, one piece of the DRX configuration information is used for indicating sub-parameters of a same type in a plurality of DRX cycle configuration parameters.

In an example, the DRX configuration information corresponding to a sub-parameter in the DRX long-cycle configuration parameters is used for indicating a sub-parameter in the DRX short-cycle configuration parameters.

In an example, in response to that a sub-parameter of a first DRX cycle configuration parameter of the N DRX cycle configuration parameters does not have the corresponding DRX configuration information, the sub-parameter of the first DRX cycle configuration parameter is determined in at least one of the following modes: the sub-parameter of the first DRX cycle configuration parameter being specified by a communication protocol; the sub-parameter of the first DRX cycle configuration parameter being a preset value; or, the sub-parameter of the first DRX cycle configuration parameter being indicated by the DRX configuration information of a second DRX cycle configuration parameter of the N DRX cycle configuration parameters.

In an example, the first DRX cycle configuration parameter is a DRX short-cycle configuration parameter, and the second DRX cycle configuration parameter is a DRX long-cycle configuration parameter.

In an example, a correspondence between DRX cycles of the different DRX cycle configuration parameters includes at least one of the following: a DRX cycle corresponding to the DRX long-cycle configuration parameter with a longer DRX cycle being X times a DRX cycle corresponding to the DRX long-cycle configuration parameter with a shorter DRX cycle, where X is a positive integer greater than or equal to 1; a DRX cycle corresponding to the DRX short-cycle configuration parameter with a longer DRX cycle being Y times a DRX cycle corresponding to the DRX short-cycle configuration parameter with a shorter DRX cycle, where Y is a positive integer greater than or equal to 1; or, a DRX cycle corresponding to the DRX long-cycle configuration parameter being Z times a DRX cycle corresponding to the DRX short-cycle configuration parameter, where Z is a positive integer greater than or equal to 1.

In an example, timers used by the different DRX cycle configuration parameters include at least one of the following: the different DRX cycle configuration parameters using different DRX-onDurationTimers; the different DRX cycle configuration parameters using different DRX-InactivityTimers; or, the different DRX short-cycle configuration parameters using different DRX-ShortCycle Timers.

In an example, timers used by the different DRX cycle configuration parameters include at least one of the following: the different DRX cycle configuration parameters using a same DRX-onDurationTimer; the different DRX cycle configuration parameters using a same DRX-InactivityTimer; or, the different DRX cycle configuration parameters using a same DRX-ShortCycleTimer.

In an example, the transceiving module 210 is further configured to: receive downlink control information with cyclic redundancy check scrambled by power saving-radio network temporary identity (DCP), where the DCP is associated with at least one of the I DRX long-cycle configuration parameters.

In an example, the DRX long-cycle configuration parameter associated with the DCP is specified by a communication protocol; or, the DRX long-cycle configuration parameter associated with the DCP is determined by indication information sent by the network-side device.

In an example, a monitoring start position of the DCP is associated with one of the I DRX long-cycle configuration parameters.

In an example, the DRX long-cycle configuration parameter associated with the monitoring start position of the DCP is specified by a communication protocol; or, the DRX long-cycle configuration parameter associated with the monitoring start position of the DCP is indicated by the network-side device.

In an example, the transceiving module 210 is further configured to: receive a discontinuous reception command medium access control control element (DRX Command MAC CE), where the DRX Command MAC CE is associated with at least one of the I DRX long-cycle configuration parameters.

In an example, at least one of: the transceiving module 210 is further configured to: receive validation indication information for indicating at least one of the valid DRX cycle configuration parameters; or, the apparatus further includes a processing module 220, configured to determine at least one of the valid DRX cycle configuration parameters based on a communication protocol.

In an example, the transceiving module 210 is specifically configured to perform at least one of the following: receiving a radio resource control (RRC) message carrying the validation indication information; receiving downlink control information (DCI) carrying the validation indication information; or, receiving a medium access control control element (MAC CE) carrying the validation indication information.

An example of the disclosure provides a communication device, including: a processor and a memory configured to store an executable instruction for the processor; where the processor is configured to: implement the method for transmitting information of any example of the disclosure when running the executable instruction.

In one example, the communication device may include, but is not limited to, at least one of: UE or a network device. Here, the network device may include a core network or an access network device, etc. Here, the access network device may include a base station; and the core network may include an AMF and an SMF.

The processor may include various types of storage media. The storage media are non-temporary computer storage media, and can continue to memorize information stored after the user equipment is powered down.

The processor may be connected with the memory via a bus and the like, and is configured to read the executable program stored on the memory, such as at least one of the methods shown in FIG. 4, or FIG. 6 to FIG. 12.

An example of the disclosure further provides a computer storage medium, storing a computer executable program, and when the executable program is executed by a processor, the method for transmitting information of any example of the disclosure is implemented, such as at least one of the methods shown in FIG. 4, or FIG. 6 to FIG. 12.

As for the apparatuses or storage media in the above example, a specific mode in which each module performs operations has been described in detail in the examples of the method, which will not be described in detail here.

According to a first aspect of the disclosure, a method for transmitting information is provided, performed by a network-side device, including: sending discontinuous reception (DRX) configuration information to user equipment (UE); where the DRX configuration information is used for indicating N DRX cycle configuration parameters, where the N DRX cycle configuration parameters include: I DRX long-cycle configuration parameters and/or J DRX short-cycle configuration parameters, where N, I and J are natural numbers, and at least one of I or J is greater than or equal to 2.

In an example, different DRX configuration information is used for indicating sub-parameters in the different DRX cycle configuration parameters.

In an example, one piece of the DRX configuration information is used for indicating sub-parameters of a same type in a plurality of the DRX cycle configuration parameters.

In an example, a DRX configuration information corresponding to a sub-parameter in the DRX long-cycle configuration parameters is used for indicating a sub-parameter in the DRX short-cycle configuration parameters.

In an example, in response to that a sub-parameter of a first DRX cycle configuration parameter of the N DRX cycle configuration parameters does not have corresponding DRX configuration information, the sub-parameter of the first DRX cycle configuration parameter is determined in at least one of the following modes: the sub-parameter of the first DRX cycle configuration parameter is specified by a communication protocol; the sub-parameter of the first DRX cycle configuration parameter is a preset value; or, the sub-parameter of the first DRX cycle configuration parameter is indicated by the DRX configuration information of a second DRX cycle configuration parameter of the N DRX cycle configuration parameters.

In an example, the first DRX cycle configuration parameter is a DRX short-cycle configuration parameter, and the second DRX cycle configuration parameter is a DRX long-cycle configuration parameter.

In an example, a correspondence between DRX cycles of the different DRX cycle configuration parameters includes at least one of the following: a DRX cycle corresponding to the DRX long-cycle configuration parameter with a longer DRX cycle is X times a DRX cycle corresponding to the DRX long-cycle configuration parameter with a shorter DRX cycle, where X is a positive integer greater than or equal to 1; a DRX cycle corresponding to the DRX short-cycle configuration parameter with a longer DRX cycle is Y times a DRX cycle corresponding to the DRX short-cycle configuration parameter with a shorter DRX cycle, where Y is a positive integer greater than or equal to 1; or, a DRX cycle corresponding to the DRX long-cycle configuration parameter is Z times a DRX cycle corresponding to the DRX short-cycle configuration parameter, where Z is a positive integer greater than or equal to 1.

In an example, timers used by the different DRX cycle configuration parameters include at least one of the following: different DRX-onDurationTimers are used by the different DRX cycle configuration parameters; different DRX-InactivityTimers are used by the different DRX cycle configuration parameters; or, different DRX-ShortCycle Timers are used by the different DRX short-cycle configuration parameters.

In an example, timers used by the different DRX cycle configuration parameters include at least one of the following: a same DRX-onDurationTimer is used by the different DRX cycle configuration parameters; a same DRX-InactivityTimer is used by the different DRX cycle configuration parameters; or, a same DRX-ShortCycleTimer is used by the different DRX cycle configuration parameters.

In an example, the method further includes: sending downlink control information with cyclic redundancy check scrambled by power saving-radio network temporary identity (DCP), where the DCP is associated with at least one of the I DRX long-cycle configuration parameters.

In an example, the DRX long-cycle configuration parameter associated with the DCP is specified by a communication protocol; or, the DRX long-cycle configuration parameter associated with the DCP is determined by indication information sent by the network-side device.

In an example, a monitoring start position of the DCP is associated with one of the I DRX long-cycle configuration parameters.

In an example, the DRX long-cycle configuration parameter associated with the monitoring start position of the DCP is specified by a communication protocol; or, the DRX long-cycle configuration parameter associated with the monitoring start position of the DCP is indicated by the network-side device.

In an example, the method further includes: sending a discontinuous reception command medium access control control element (DRX Command MAC CE), where the DRX Command MAC CE is associated with at least one of the I DRX long-cycle configuration parameters.

In an example, the method further includes at least one of the following: sending validation indication information for indicating at least one of the valid DRX cycle configuration parameters; or, determining at least one of the valid DRX cycle configuration parameters based on a communication protocol.

In an example, sending the validation indication information includes at least one of the following: sending a radio resource control (RRC) message carrying the validation indication information; sending downlink control information (DCI) carrying the validation indication information; or sending a medium access control control element (MAC CE) carrying the validation indication information.

According to a second aspect of the disclosure, a method for transmitting information is provided, performed by user equipment (UE), including: receiving discontinuous reception (DRX) configuration information sent by a network-side device; where the DRX configuration information is used for indicating N DRX cycle configuration parameters, where the N DRX cycle configuration parameters include: I DRX long-cycle configuration parameters and/or J DRX short-cycle configuration parameters, where N, I and J are natural numbers, and at least one of I or J is greater than or equal to 2.

In an example, different DRX configuration information is used for indicating sub-parameters in the different DRX cycle configuration parameters.

In an example, one piece of the DRX configuration information is used for indicating sub-parameters of a same type in a plurality of the DRX cycle configuration parameters.

In an example, a DRX configuration information corresponding to a sub-parameter in the DRX long-cycle configuration parameters is used for indicating a sub-parameter in the DRX short-cycle configuration parameters.

In an example, in response to that a sub-parameter of a first DRX cycle configuration parameter of the N DRX cycle configuration parameters does not have corresponding DRX configuration information, the sub-parameter of the first DRX cycle configuration parameter is determined in at least one of the following modes: the sub-parameter of the first DRX cycle configuration parameter is specified by a communication protocol; the sub-parameter of the first DRX cycle configuration parameter is a preset value; or, the sub-parameter of the first DRX cycle configuration parameter is indicated by the DRX configuration information of a second DRX cycle configuration parameter of the N DRX cycle configuration parameters.

In an example, the first DRX cycle configuration parameter is a DRX short-cycle configuration parameter, and the second DRX cycle configuration parameter is a DRX long-cycle configuration parameter.

In an example, a correspondence between DRX cycles of the different DRX cycle configuration parameters includes at least one of the following: a DRX cycle corresponding to the DRX long-cycle configuration parameter with a longer DRX cycle is X times a DRX cycle corresponding to the DRX long-cycle configuration parameter with a shorter DRX cycle, where X is a positive integer greater than or equal to 1; a DRX cycle corresponding to the DRX short-cycle configuration parameter with a longer DRX cycle is Y times a DRX cycle corresponding to the DRX short-cycle configuration parameter with a shorter DRX cycle, where Y is a positive integer greater than or equal to 1; or, a DRX cycle corresponding to the DRX long-cycle configuration parameter is Z times a DRX cycle corresponding to the DRX short-cycle configuration parameter, where Z is a positive integer greater than or equal to 1.

In an example, timers used by the different DRX cycle configuration parameters include at least one of the following: different DRX-onDurationTimers are used by the different DRX cycle configuration parameters; different DRX-InactivityTimers are used by the different DRX cycle configuration parameters; or, different DRX-ShortCycle Timers are used by the different DRX short-cycle configuration parameters.

In an example, timers used by the different DRX cycle configuration parameters include at least one of the following: a same DRX-onDuration Timer is used by the different DRX cycle configuration parameters; a same DRX-InactivityTimer is used by the different DRX cycle configuration parameters; or, a same DRX-ShortCycleTimer is used by the different DRX cycle configuration parameters.

In an example, the method further includes: receiving downlink control information with cyclic redundancy check scrambled by power saving-radio network temporary identity (DCP), where the DCP is associated with at least one of the I DRX long-cycle configuration parameters.

In an example, the DRX long-cycle configuration parameter associated with the DCP is specified by a communication protocol; or, the DRX long-cycle configuration parameter associated with the DCP is determined by indication information sent by the network-side device.

In an example, a monitoring start position of the DCP is associated with one of the I DRX long-cycle configuration parameters.

In an example, the DRX long-cycle configuration parameter associated with the monitoring start position of the DCP is specified by a communication protocol; or, the DRX long-cycle configuration parameter associated with the monitoring start position of the DCP is indicated by the network-side device.

In an example, the method further includes: receiving a discontinuous reception command medium access control control element (DRX Command MAC CE), where the DRX Command MAC CE is associated with at least one of the I DRX long-cycle configuration parameters.

In an example, the method further includes at least one of the following: receiving validation indication information for indicating at least one of the valid DRX cycle configuration parameters; or, determining at least one of the valid DRX cycle configuration parameters based on a communication protocol.

In an example, receiving the validation indication information includes at least one of the following: receiving a radio resource control (RRC) message carrying the validation indication information; receiving downlink control information (DCI) carrying the validation indication information; or, receiving a medium access control control element (MAC CE) carrying the validation indication information.

According to a third aspect of the disclosure, an apparatus for transmitting information is provided, arranged in a network-side device, including: a transceiving module, configured to send discontinuous reception (DRX) configuration information to user equipment (UE); where the DRX configuration information is used for indicating N DRX cycle configuration parameters, where the N DRX cycle configuration parameters include: I DRX long-cycle configuration parameters and/or J DRX short-cycle configuration parameters, where N, I and J are natural numbers, and at least one of I or J is greater than or equal to 2.

In an example, the different DRX configuration information is used for indicating sub-parameters in the different DRX cycle configuration parameters.

In an example, one piece of the DRX configuration information is used for indicating sub-parameters of a same type in a plurality of the DRX cycle configuration parameters.

In an example, a DRX configuration information corresponding to a sub-parameter in the DRX long-cycle configuration parameters is used for indicating a sub-parameter in the DRX short-cycle configuration parameters.

In an example, in response to that a sub-parameter of a first DRX cycle configuration parameter of the N DRX cycle configuration parameters does not have corresponding DRX configuration information, the sub-parameter of the first DRX cycle configuration parameter is determined in at least one of the following modes: the sub-parameter of the first DRX cycle configuration parameter is specified by a communication protocol; the sub-parameter of the first DRX cycle configuration parameter is a preset value; or, the sub-parameter of the first DRX cycle configuration parameter is indicated by the DRX configuration information of a second DRX cycle configuration parameter of the N DRX cycle configuration parameters.

In an example, the first DRX cycle configuration parameter is a DRX short-cycle configuration parameter, and the second DRX cycle configuration parameter is a DRX long-cycle configuration parameter.

In an example, a correspondence between DRX cycles of the different DRX cycle configuration parameters includes at least one of the following: a DRX cycle corresponding to the DRX long-cycle configuration parameter with a longer DRX cycle is X times a DRX cycle corresponding to the DRX long-cycle configuration parameter with a shorter DRX cycle, where X is a positive integer greater than or equal to 1; a DRX cycle corresponding to the DRX short-cycle configuration parameter with a longer DRX cycle is Y times a DRX cycle corresponding to the DRX short-cycle configuration parameter with a shorter DRX cycle, where Y is a positive integer greater than or equal to 1; or, a DRX cycle corresponding to the DRX long-cycle configuration parameter is Z times a DRX cycle corresponding to the DRX short-cycle configuration parameter, where Z is a positive integer greater than or equal to 1.

In an example, timers used by the different DRX cycle configuration parameters include at least one of the following: different DRX-onDurationTimers are used by the different DRX cycle configuration parameters; different DRX-InactivityTimers are used by the different DRX cycle configuration parameters; or, different DRX-ShortCycleTimers are used by the different DRX short-cycle configuration parameters.

In an example, timers used by the different DRX cycle configuration parameters include at least one of the following: a same DRX-onDuration Timer is used by the different DRX cycle configuration parameters; a same DRX-InactivityTimer is used by the different DRX cycle configuration parameters; or, a same DRX-ShortCycleTimer is used by the different DRX cycle configuration parameters.

In an example, the transceiving module is further configured to: send downlink control information with cyclic redundancy check scrambled by power saving-radio network temporary identity (DCP), where the DCP is associated with at least one of the I DRX long-cycle configuration parameters.

In an example, the DRX long-cycle configuration parameter associated with the DCP is specified by a communication protocol; or, the DRX long-cycle configuration parameter associated with the DCP is determined by indication information sent by the network-side device.

In an example, a monitoring start position of the DCP is associated with one of the I DRX long-cycle configuration parameters.

In an example, the DRX long-cycle configuration parameter associated with the monitoring start position of the DCP is specified by a communication protocol; or, the DRX long-cycle configuration parameter associated with the monitoring start position of the DCP is indicated by the network-side device.

In an example, the transceiving module is further configured to: send a discontinuous reception command medium access control control element (DRX Command MAC CE), where the DRX Command MAC CE is associated with at least one of the I DRX long-cycle configuration parameters.

In an example, the transceiving module is further configured to: send validation indication information for indicating at least one of the valid DRX cycle configuration parameters; and/or, the apparatus further includes a processing module, configured to determine at least one of the valid DRX cycle configuration parameters based on a communication protocol.

In an example, the transceiving module is specifically configured to perform at least one of the following: send a radio resource control (RRC) message carrying the validation indication information; send downlink control information (DCI) carrying the validation indication information; or send a medium access control control element (MAC CE) carrying the validation indication information.

According to a fourth aspect of the disclosure, an apparatus for transmitting information is provided, arranged in user equipment (UE), including: a transceiving module, configured to receive discontinuous reception (DRX) configuration information sent by a network-side device; where the DRX configuration information is used for indicating N DRX cycle configuration parameters, where the N DRX cycle configuration parameters include: I DRX long-cycle configuration parameters and/or J DRX short-cycle configuration parameters, where N, I and J are natural numbers, and at least one of I or J is greater than or equal to 2.

In an example, the different DRX configuration information is used for indicating sub-parameters in the different DRX cycle configuration parameters.

In an example, one piece of the DRX configuration information is used for indicating sub-parameters of a same type in a plurality of the DRX cycle configuration parameters.

In an example, a DRX configuration information corresponding to a sub-parameter in the DRX long-cycle configuration parameters is used for indicating a sub-parameter in the DRX short-cycle configuration parameters.

In an example, in response to that a sub-parameter of a first DRX cycle configuration parameter of the N DRX cycle configuration parameters does not have corresponding DRX configuration information, the sub-parameter of the first DRX cycle configuration parameter is determined in at least one of the following modes: the sub-parameter of the first DRX cycle configuration parameter is specified by a communication protocol; the sub-parameter of the first DRX cycle configuration parameter is a preset value; or, the sub-parameter of the first DRX cycle configuration parameter is indicated by the DRX configuration information of a second DRX cycle configuration parameter of the N DRX cycle configuration parameters.

In an example, the first DRX cycle configuration parameter is a DRX short-cycle configuration parameter, and the second DRX cycle configuration parameter is a DRX long-cycle configuration parameter.

In an example, a correspondence between DRX cycles of the different DRX cycle configuration parameters includes at least one of the following: a DRX cycle corresponding to the DRX long-cycle configuration parameter with a longer DRX cycle is X times a DRX cycle corresponding to the DRX long-cycle configuration parameter with a shorter DRX cycle, where X is a positive integer greater than or equal to 1; a DRX cycle corresponding to the DRX short-cycle configuration parameter with a longer DRX cycle is Y times a DRX cycle corresponding to the DRX short-cycle configuration parameter with a shorter DRX cycle, where Y is a positive integer greater than or equal to 1; or, a DRX cycle corresponding to the DRX long-cycle configuration parameter is Z times a DRX cycle corresponding to the DRX short-cycle configuration parameter, where Z is a positive integer greater than or equal to 1.

In an example, timers used by the different DRX cycle configuration parameters include at least one of the following: different DRX-onDurationTimers are used by the different DRX cycle configuration parameters; different DRX-InactivityTimers are used by the different DRX cycle configuration parameters; or, different DRX-ShortCycleTimers are used by the different DRX short-cycle configuration parameters.

In an example, timers used by the different DRX cycle configuration parameters include at least one of the following: a same DRX-onDuration Timer is used by the different DRX cycle configuration parameters; a same DRX-InactivityTimer is used by the different DRX cycle configuration parameters; or, a same DRX-ShortCycleTimer is used by the different DRX cycle configuration parameters.

In an example, the transceiving module is further configured to: receive downlink control information with cyclic redundancy check scrambled by power saving-radio network temporary identity (DCP), where the DCP is associated with at least one of the I DRX long-cycle configuration parameters.

In an example, the DRX long-cycle configuration parameter associated with the DCP is specified by a communication protocol; or, the DRX long-cycle configuration parameter associated with the DCP is determined by indication information sent by the network-side device.

In an example, a monitoring start position of the DCP is associated with one of the I DRX long-cycle configuration parameters.

In an example, the DRX long-cycle configuration parameter associated with the monitoring start position of the DCP is specified by a communication protocol; or, the DRX long-cycle configuration parameter associated with the monitoring start position of the DCP is indicated by the network-side device.

In an example, the transceiving module is further configured to: receive a discontinuous reception command medium access control control element (DRX Command MAC CE), where the DRX Command MAC CE is associated with at least one of the I DRX long-cycle configuration parameters.

In an example, the transceiving module is further configured to: receive validation indication information for indicating at least one of the valid DRX cycle configuration parameters; and/or, the apparatus further includes a processing module, configured to determine at least one of the valid DRX cycle configuration parameters based on a communication protocol.

In an example, the transceiving module is specifically configured to perform at least one of the following: receive a radio resource control (RRC) message carrying the validation indication information; receive downlink control information (DCI) carrying the validation indication information; or, receive a medium access control control element (MAC CE) carrying the validation indication information.

According to a fifth aspect of the disclosure, a communication device is provided, including: one or more processors and a memory configured to store an executable instruction for the one or more processors; where the one or more processors are collectively configured to: implement the method for transmitting information when running the executable instruction.

According to a sixth aspect of the disclosure, a non-transitory computer-readable storage medium is provided, storing a computer executable program, and when the computer executable program is executed by one or more processors, the method for transmitting information is implemented.

In the examples of the disclosure, the DRX configuration information is sent to the UE by the network-side device; where the DRX configuration information is used for indicating N DRX cycle configuration parameters, where the N DRX cycle configuration parameters include: I DRX long-cycle configuration parameters and/or J DRX short-cycle configuration parameters, where N, I and J are natural numbers, and at least one of I or J is greater than or equal to 2. Thus, by configuring a plurality of DRX cycle configuration parameters, DRX meets cycle changes of different service data transmission, a data transmission delay generated due to the inconsistency between a service data transmission cycle and the DRX cycle is reduced, a data transmission demand is met while UE power is saved, and data transmission efficiency is improved.

FIG. 15 is a block diagram of user equipment 3000 illustrated according to an example. For example, the user equipment 3000 may be a mobile phone, a computer, digital broadcasting user equipment, a messaging device, a game console, a tablet device, a medical device, a fitness device, a personal digital assistant, etc.

Referring to FIG. 15, the user equipment 3000 may include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 typically controls an overall operation of the user equipment 3000, such as operations associated with display, a telephone call, a data communication, a camera operation, and a recording operation. The processing component 3002 may include one or more processors 3020 to execute instructions to complete all or part of the steps of the above method. In addition, the processing component 3002 may include one or more modules to facilitate interaction between the processing component 3002 and other components. For example, the processing component 3002 may include a multimedia module to facilitate interaction between the multimedia component 3008 and the processing component 3002.

The memory 3004 is configured to store various types of data to support operations at the user equipment 3000. Examples of these data include instructions for any application or method operating on the user equipment 3000, contact data, phonebook data, messages, pictures, videos, etc. The memory 3004 may be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 3006 provides power for various components of the user equipment 3000. The power component 3006 may include a power management system, one or more power sources and other components associated with generating, managing and distributing power for the user equipment 3000.

The multimedia component 3008 includes a screen providing an output interface between the user equipment 3000 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense a touch, sliding and gestures on the touch panel. The touch sensor can not only sense the boundary of the touch or sliding operation, but also detect the duration and pressure related to the touch or sliding operation. In some examples, the multimedia component 3008 includes a front camera and/or a rear camera. When the user equipment 3000 is in an operation mode, such as a shooting mode or a video mode, the front camera and/or the rear camera can receive external multimedia data. Each front camera and rear camera may be a fixed optical lens system or have a focal length and optical zoom capability.

The audio component 3010 is configured to output and/or input audio signals. For example, the audio component 3010 includes a microphone (MIC) configured to receive an external audio signal when the user equipment 3000 is in the operation mode, such as a call mode, a recording mode, and a speech recognition mode. The received audio signal may be further stored in the memory 3004 or sent via the communication component 3016. In some examples, the audio component 3010 further includes a speaker for outputting an audio signal.

The I/O interface 3012 provides an interface between the processing component 3002 and a peripheral interface module which may be a keyboard, a click wheel, a button, etc. These buttons may include but are not limited to: a home button, a volume button, a start button and a lock button.

The sensor component 3014 includes one or more sensors for providing state evaluation of various aspects of the user equipment 3000. For example, the sensor component 3014 may detect an open/closed state of the user equipment 3000, the relative positioning of components, such as the components being a display and a keypad of the user equipment 3000, and the sensor component 3014 may also detect a change in the position of the user equipment 3000 or of a component of the user equipment 3000, the presence or absence of user contact with the user equipment 3000, an orientation or acceleration/deceleration of the user equipment 3000, and a change in temperature of the user equipment 3000. The sensor component 3014 may include a proximity sensor configured to detect the presence of nearby objects without any physical contact. The sensor component 3014 may further include an optical sensor, such as a CMOS or CCD image sensor, for use in imaging applications. In some examples, the sensor component 3014 may further include an acceleration sensor, a gyroscope sensor, a magnetic sensor, a pressure sensor, or a temperature sensor.

The communication component 3016 is configured to facilitate wired or wireless communication between the user equipment 3000 and other devices. The user equipment 3000 may access a wireless network based on a communication standard, such as Wi-Fi, 4G or 5G, or their combination. In an example, the communication component 3016 receives a broadcast signal or broadcast-related information from an external broadcast management system via a broadcast channel. In an example, the communication component 816 further includes a near field communication (NFC) module to facilitate short-range communication. For example, the NFC module may be implemented based on radio frequency identification (RFID) technology, infrared data association (IrDA) technology, ultra wideband (UWB) technology, Bluetooth (BT) technology and other technologies.

In an example, the user equipment 3000 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for executing the above methods.

In an example, a non-temporary computer-readable storage medium including instructions, such as the memory 3004 including instructions, which can be executed by the processor 3020 of the user equipment 3000 to complete the above method, is further provided. For example, the non-temporary computer-readable storage medium may be an ROM, a random access memory (RAM), a CD-ROM, a magnetic tape, a floppy disk, an optical data storage device, etc.

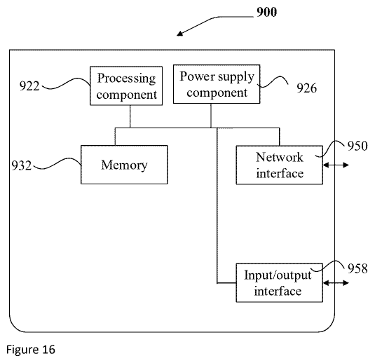

As shown in FIG. 16, an example of the disclosure shows a structure of a base station. For example, the base station 900 may be provided as a network side device. Referring to FIG. 16, the base station 900 includes a processing component 922, which further includes one or more processors, and a memory resource represented by a memory 932 for storing instructions, such as applications, that can be executed by the processing component 922. The applications stored in the memory 932 may include one or more modules each corresponding to a set of instructions. In addition, the processing component 922 is configured to execute instructions to execute any method applied to the base station above.

The base station 900 may further include a power component 926 configured to perform power management of the base station 900, a wired or wireless network interface 950 configured to connect the base station 900 to the network, and an input/output (I/O) interface 958. The base station 900 can operate an operating system based on the memory 932, such as Windows Server™, Mac OS X™, Unix™, Linux™, FreeBSD™, or the like.

Other examples of the disclosure will be apparent to those skilled in the art from consideration of the specification and practice of the disclosure here. The disclosure is intended to cover any variations, uses, or adaptations of the disclosure that follow the general principles of the disclosure and include common knowledge or customary technical means in the technical field not disclosed here. It is intended that the specification and examples be considered as exemplary only, with a true scope and spirit of the disclosure being indicated by the following claims.

It will be appreciated that the disclosure is not limited to the exact construction that has been described above and illustrated in the accompanying drawings, and that various modifications and changes may be made without departing from the scope of the disclosure. The scope of the disclosure is merely limited by the appended claims.

1. A method for transmitting information, performed by a network device, comprising:
sending discontinuous reception (DRX) configuration information to user equipment (UE); wherein the DRX configuration information is used for indicating N DRX cycle configuration parameters, wherein the N DRX cycle configuration parameters comprise at least one of: I DRX long-cycle configuration parameters and/or J DRX short-cycle configuration parameters, wherein N, I and J are natural numbers, and at least one of I or J is greater than or equal to 2.

2. The method according to claim 1, wherein
different DRX configuration information is used for indicating sub-parameters in different DRX cycle configuration parameters.

3. The method according to claim 1, wherein
one piece of the DRX configuration information is used for indicating sub-parameters of a same type in a plurality of the DRX cycle configuration parameters.

4. The method according to claim 1, wherein
a DRX configuration information corresponding to a sub-parameter in the DRX long-cycle configuration parameters is used for indicating a sub-parameter in the DRX short-cycle configuration parameters.

5. The method according to claim 1, wherein
in response to that a sub-parameter of a first DRX cycle configuration parameter of the N DRX cycle configuration parameters does not comprise DRX configuration information, the sub-parameter of the first DRX cycle configuration parameter is determined based on at least one of:
the sub-parameter of the first DRX cycle configuration parameter specifying a communication protocol;
the sub-parameter of the first DRX cycle configuration parameter including a preset value; or
the sub-parameter of the first DRX cycle configuration parameter indicating the DRX configuration information of a second DRX cycle configuration parameter of the N DRX cycle configuration parameters.

6. The method according to claim 5, wherein
the first DRX cycle configuration parameter is a DRX short-cycle configuration parameter, and the second DRX cycle configuration parameter is a DRX long-cycle configuration parameter.

7. The method according to claim 1, wherein a correspondence between DRX cycles of different DRX cycle configuration parameters comprises at least one of:
a DRX cycle corresponding to the DRX long-cycle configuration parameter with a longer DRX cycle is X times a DRX cycle corresponding to the DRX long-cycle configuration parameter with a shorter DRX cycle, wherein X is a positive integer greater than or equal to 1;
a DRX cycle corresponding to the DRX short-cycle configuration parameter with a longer DRX cycle is Y times a DRX cycle corresponding to the DRX short-cycle configuration parameter with a shorter DRX cycle, wherein Y is a positive integer greater than or equal to 1; or
a DRX cycle corresponding to the DRX long-cycle configuration parameter is Z times a DRX cycle corresponding to the DRX short-cycle configuration parameter, wherein Z is a positive integer greater than or equal to 1.

8. The method according to claim 1, wherein timers used by different DRX cycle configuration parameters comprise at least one of:
different DRX-onDurationTimers are used by the different DRX cycle configuration parameters;
different DRX-InactivityTimers are used by the different DRX cycle configuration parameters; or
different DRX-ShortCycleTimers are used by different DRX short-cycle configuration parameters;
a same DRX-onDurationTimer is used by different DRX cycle configuration parameters;
a same DRX-InactivityTimer is used by the different DRX cycle configuration parameters; or
a same DRX-ShortCycle Timer is used by the different DRX cycle configuration parameters.

9. (canceled)

10. The method according to claim 1, further comprising:
sending downlink control information with cyclic redundancy check scrambled by power saving-radio network temporary identity (DCP), wherein the DCP is associated with at least one of the I DRX long-cycle configuration parameters.

11. The method according to claim 10, wherein
a DRX long-cycle configuration parameter associated with the DCP is specified by a communication protocol;
or,
the DRX long-cycle configuration parameter associated with the DCP is determined by indication information sent by the network-side device.

12. The method according to claim 10, wherein
a monitoring start position of the DCP is associated with one of the I DRX long-cycle configuration parameters.

13. The method according to claim 12, wherein
a DRX long-cycle configuration parameter associated with the monitoring start position of the DCP is specified by a communication protocol;
or,
the DRX long-cycle configuration parameter associated with the monitoring start position of the DCP is indicated by the network device.

14. The method according to claim 1, further comprising:
sending a discontinuous reception command medium access control control element (DRX Command MAC CE), wherein the DRX Command MAC CE is associated with at least one of the I DRX long-cycle configuration parameters.

15. The method according to claim 1, further comprising at least one of:
sending validation indication information for indicating at least one of valid DRX cycle configuration parameters; or
determining at least one of the valid DRX cycle configuration parameters based on a communication protocol.

16. The method according to claim 15, wherein sending the validation indication information comprises at least one of:
sending a radio resource control (RRC) message carrying the validation indication information;
sending downlink control information (DCI) carrying the validation indication information; or
sending a medium access control control element (MAC CE) carrying the validation indication information.

17. A method for transmitting information, performed by user equipment (UE), comprising:
receiving discontinuous reception (DRX) configuration information sent by a network device; wherein the DRX configuration information is used for indicating N DRX cycle configuration parameters, wherein the N DRX cycle configuration parameters comprise at least one of: I DRX long-cycle configuration parameters or J DRX short-cycle configuration parameters, wherein N, I and J are natural numbers, and at least one of I or J is greater than or equal to 2.

18. The method according to claim 17, wherein
different DRX configuration information is used for indicating sub-parameters in different DRX cycle configuration parameters.

19. The method according to claim 17, wherein
one piece of the DRX configuration information is used for indicating sub-parameters of a same type in a plurality of the DRX cycle configuration parameters.

20-34. (canceled)

35. A communication device, comprising:
one or more processors; and
a memory configured to store an executable instruction for the one or more processors;
wherein the one or more processor are collectively configured to:
send discontinuous reception (DRX) configuration information to user equipment (UE); wherein the DRX configuration information is used for indicating N DRX cycle configuration parameters, wherein the N DRX cycle configuration parameters comprise at least one of: I DRX long-cycle configuration parameters or J DRX short-cycle configuration parameters, wherein N, I and J are natural numbers, and at least one of I or J is greater than or equal to 2.

36. A non-transitory computer-readable storage medium, storing a computer executable program, wherein the computer executable program when executed by one or more processors of the network device, cause the network device to perform the method for transmitting information according to claim 1.
